(19) United States
(12) Patent Application Publication
(10) Pub. No.: US 2024/0167239 A1
(43) Pub. Date: May 23, 2024

(54) SCALED HYDROPOWER WITH SEALS

(71) Applicant: LITTORAL POWER SYSTEMS, INC., NEW BEDFORD, MA (US)

(72) Inventors: Katherine T. Leighton, Media, PA (US); David J. Duquette, New Bedford, MA (US); Chad W. Cox, Brookline, MA (US); Mark Graeser, Littleton, CO (US)

(73) Assignee: LITTORAL POWER SYSTEMS, INC., NEW BEDFORD, MA (US)

(21) Appl. No.: 18/366,372

(22) Filed: Aug. 7, 2023

Related U.S. Application Data
(63) Continuation-in-part of application No. 18/151,995, filed on Jan. 9, 2023.
Application No. 18/151,995 is a continuation of application No. 16/883,970, filed on May 26, 2020, now Pat. No. 11,566,392.
(60) Provisional application No. 62/852,066, filed on May 23, 2019.

(51) Int. Cl. E02B 8/08

(52) U.S. Cl. CPC E02B 8/085

(57) ABSTRACT

A hydropower system comprised of prefabricated modules. The system includes an assembly having a first plurality of modules forming a first vertical stack and a second plurality of modules forming a second vertical stack. Each of the vertical stacks also includes at least one of: a first plurality of horizontal seals between the first plurality of modules, and a second plurality of horizontal seals between the second plurality of modules. Each of the vertical stacks further includes a plurality of vertical seals installed between the first plurality of modules and the second plurality of modules.

### CROSS-REFERENCE TO RELATED APPLICATIONS

This application is a continuation-in-part (CIP) of U.S. patent application Ser. No. 18/151,995, filed Jan. 9, 2023, which is a continuation of U.S. patent application Ser. No. 16/883,970, filed May 26, 2020, which claims the benefit of U.S. Provisional Patent Application No. 62/852,066, filed May 23, 2019, the disclosures of each of which are incorporated by reference, in their entirety.

### STATEMENT REGARDING GOVERNMENT INTEREST

This invention was made with government support under DE-EE0007243 awarded by the Department of Energy. The government has certain rights in the invention.

### ADDITIONAL REFERENCES

U.S. Pat. No. 10,626,569 is hereby incorporated herein by reference in its entirety.

### FIELD OF THE INVENTION

The present invention generally relates to fish passages for use with dams and hydropower, and more specifically to fish passages and scaled hydropower.

### BACKGROUND

Hydropower or water power is power derived from the energy of falling or fast-running water, which may be harnessed for useful purposes. Since ancient times, hydropower from many kinds of watermills has been used as a renewable energy source for irrigation and the operation of various mechanical devices. In the late 19th century, hydropower became a source for generating electricity. Since the early 20th century, the term has been used almost exclusively in conjunction with the modern development of hydroelectric power. International institutions such as the World Bank view hydropower as a means for economic development without adding substantial amounts of carbon to the atmosphere, but dams can have significant negative environmental impacts. One of the most problematic environmental issues is blocked passage for migratory fish, particularly anadromous and catadromous species. Hydropower licensing agencies—such as the Federal Energy Regulatory Commission in the USA—routinely require as a condition of operation that safe, timely and effective fish passage equipment at any hydropower plant be provided for. The problem is that doing so in a manner that is acceptable to authorities and stakeholders is extremely expensive, especially at smaller hydropower facilities where it becomes a disproportionate part of project cost and as such can render such efforts financially unworkable. As such, a lower cost approach that is effective at passing fish safely is of the utmost importance to owners and developers of small hydropower installations.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In one embodiment, an assembly includes a first vertical stack having a first module and a second module made of cast-in-place concrete with or without bar or fiber reinforcement, or precast concrete with or without bar or fiber reinforcement, or steel alloy, or aluminum alloy, or glass fiber reinforced plastic, or carbon reinforced plastic or a hybrid or combination of any two or more of these materials, and a first seal horizontally installed between the first module and the second module, and a second vertical stack having a third module and a fourth module made of cast-in-place concrete with or without bar or fiber reinforcement, or precast concrete with or without bar or fiber reinforcement, or steel alloy, or aluminum alloy, or glass fiber reinforced plastic, or carbon reinforced plastic or a hybrid or combination of any two or more of these materials, and a second seal horizontally installed between the third module and the fourth module. The assembly further includes a third seal vertically installed between the first module and the third module, the third seal configured to span across vertical joints between the first vertical stack and the second vertical stack. The horizontal seals and the vertical seals are configured to provide near water-tight connections between the horizontal joints and the vertical joints such that the assembly has a leakage rate of less than about 0.1 gallon per minute per linear foot of joint.

In one embodiment, an assembly includes a first plurality of modules assembled to form a first vertical stack and a second plurality of modules assembled to form a second vertical stack. Each of the first vertical stack and the second vertical stack includes at least one of: a first plurality of horizontal seals between the first plurality of modules, and a second plurality of horizontal seals between the second plurality of modules. The assembly further includes a plurality of vertical seals installed between the first plurality of modules and the second plurality of modules. The first plurality of horizontal seals, the second plurality of horizontal seals, and the plurality of vertical seals are configured such that the system has a leakage rate of less than about 0.1 gallon per minute per linear foot of joint.

In one embodiment, a system includes an assembly configured to secure to a foundation. The assembly includes: a first vertical stack having first module and second module, and first seal horizontally installed between the first module and the second module, and a second vertical stack having third module and fourth module, and second seal horizontally installed between the third module and the fourth module/The assembly further includes a third seal vertically installed between the first module and the third module, and between the second and fourth module, the third seal configured to span across vertical joints between the first module and the third module and to span across vertical joints between the second module and the fourth module, which includes the quad point. The first seal, the second seal, and the third seal are configured to provide low-leakage connections between and among the first module, the second module, the third module, the fourth module of the first vertical stack and the second vertical stack such that the system produces acceptable leakage levels.

In one embodiment, an assembly includes a first vertical stack having a first module, and a first seal horizontally installed between the first module and a foundation on which the assembly is disposed; a second vertical stack having a second module, and a second seal horizontally installed between the second module and the foundation. The assembly further includes a third seal vertically installed between the first module and the second module, the third seal configured to span across vertical joints between the first vertical stack and the second vertical stack. The horizontal seals and the vertical seal are configured to provide near water-tight connections between the vertical joints such that the assembly has a leakage rate of less than about 0.1 gallon per minute per linear foot of joint.

In one embodiment, an assembly includes a first vertical stack having a first module and a second module, and a first seal horizontally installed between the first module and the second module. The horizontal seal is configured to provide near water-tight connections between horizontal joints of the first and second module such that the assembly has a leakage rate of less than about 0.1 gallon per minute per linear foot of joint.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIGS. 1A-1D illustrate an exemplary embodiment of a modular upstream fish passage system configured in accordance with the present invention.

FIGS. 2-4 illustrate another exemplary embodiment of a modular fish passage system configured in accordance with the present invention.

FIG. 5 illustrates an exemplary downstream fish passage system implemented on a dam.

FIGS. 6 and 7 illustrate features of a conduit configured for use with an embodiment of the fish passage system of FIG. 5.

FIGS. 8 and 9 illustrate different views of an embodiment of the downstream fish passage system of FIG. 5.

FIG. 10 illustrates features of a conduit having inner and outer tube sections, and configured for use with an embodiment of the fish passage system of FIG. 5.

FIG. 11 is an illustration of an exemplary small module hydroelectric facility configured in accordance with an embodiment of the present invention.

FIGS. 12A and 12B illustrate a section view of a generation module stack configured in accordance with an embodiment of the present invention.

FIGS. 13A and 13B illustrate a section view of a water passage module stack configured in accordance with an embodiment of the present invention.

FIGS. 14 and 15A-15G illustrate exemplary seals implemented on module stacks in accordance with an embodiment of the present invention.

FIG. 16 is an illustration of an exemplary site plan of a facility showing an angled powerhouse.

FIG. 17 is an illustration of a foundation of interlocking precast concrete planks in accordance with an embodiment of the present invention.

FIGS. 18A and 18B are illustrations of an exemplary small standardized prefabricated module hydropower (“SSPMH”) facility.

FIG. 19 is a perspective view of a module stack in accordance with an embodiment of the present invention.

FIG. 20 is a close-up of a portion of the module stack of FIG. 19.

FIGS. 21A-21D are top and side views of a horizontal seal according to an embodiment.

FIGS. 22A-22E are perspective, top, bottom and cross-sectional views of a female column end cap according to an embodiment.

FIGS. 23A-23E are perspective, top, bottom and cross-sectional views of a bottom column end cap according to an embodiment.

FIGS. 24A-24C are bottom, cross-sectional and perspective views, respectively, of a vertical seal according to an embodiment.

FIGS. 25A-25K are images and photographs of a test apparatus and a test fixture for testing leakage level for vertical and horizontal seals of a module stack in accordance with the present disclosure.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

Generally, in various embodiments, the present invention provides a fish passage system that can be easily assembled onsite and installed in a waterway, so that fish (e.g., salmon, shad and river herring) can overcome dams, hydropower facilities, and other obstacles encountered during migration. The fish passage can be disassembled and transported to and from sites. The disclosed fish passage system can be configured as a volitional or non-volitional passage depending on what ancillary attraction flow systems are utilized. Volitional fish passages can be defined as those that rely upon motivation, performance, and behavior of the fish to enter and ascend over the barrier, as opposed to non-volitional ones that rely on mechanical or human assistance such as lifts, elevators, fish locks, and trap-and-transport systems.

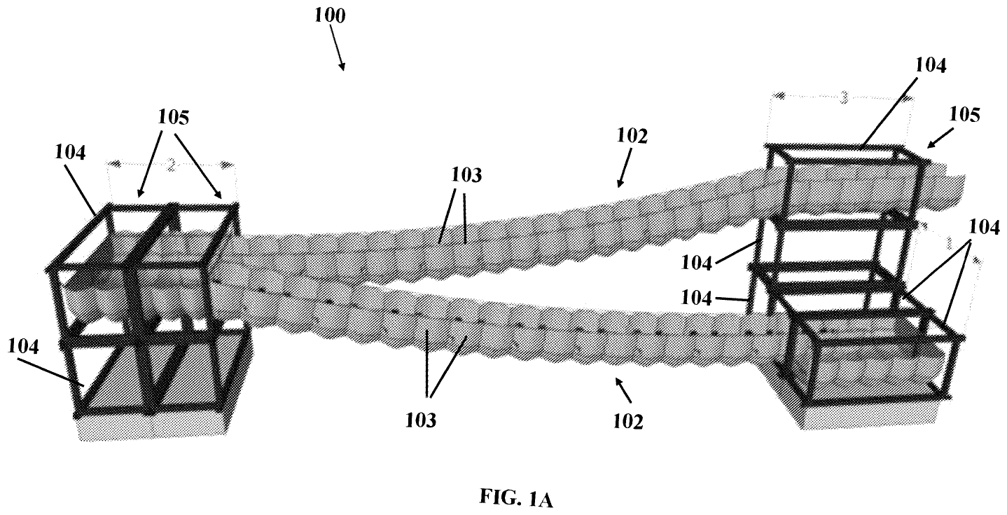

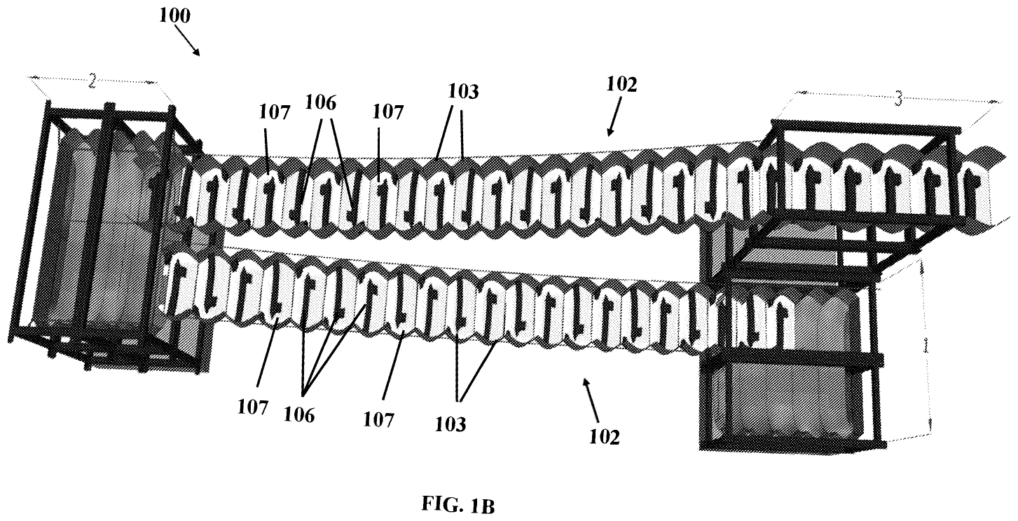

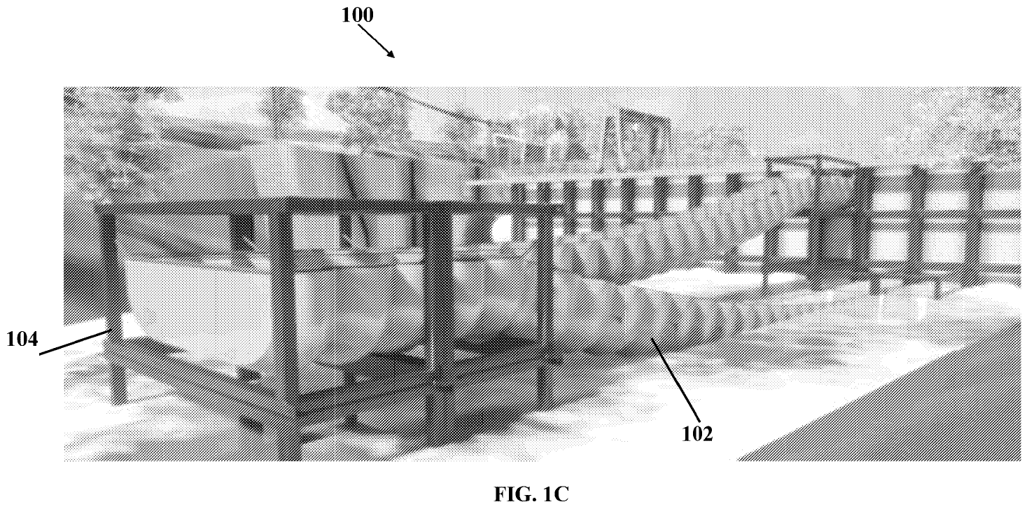

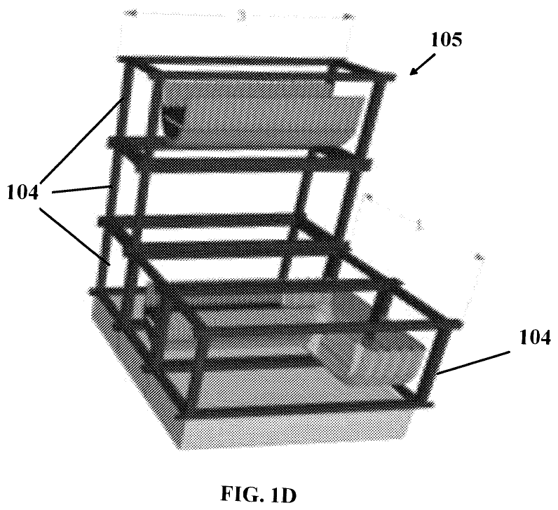

Referring to FIGS. 1A-1D, in an embodiment, the present invention provides an upstream fish passage system 100 that can include an expandable chute or conduit 102 supported by one or more modules 104 that provide a supporting structural framework. The conduit 102 has an upstream end through which fish exit the fish passage system 100, and downstream end through which fish enter the fish passage system 100. The conduit 102 can be made of flexible, high-strength textile materials including, but not limited to, high density polyethylene (e.g., Dyneemak® or Spectra®), para-aramids (e.g., Kevlark®, Twaron®), meta-aramids (e.g., Conex®, Nomex®), high strength nylon (e.g., nylon 6,6, Cordura®), and reinforced rubber. The textile materials can be rubberized for water containment and can include additives for UV stabilization.

The conduit 102 can be configured as a series of interconnected pools 103. A series of baffles 106 can be disposed along the conduit 102 at regular intervals to separate the pools 103. Each baffle 106 can be adjustable in height and width to create a baffle throughway 107 between an end of the baffle 106 and an inside surface of the chute/conduit 102. In an embodiment, the baffles 106 can be attached and secured to walls of the chute/conduit 102 with textile gussets or other fasteners. The baffles 106 can be made of the same or similar textile materials as the conduit 102. The fish passage system 100 can be assembled on site from a prefabricated, standardized, and modular kit of parts. The kit of parts can be configured to accommodate various passage heights, e.g., from about 7 to about 50 feet.

In an embodiment, the modules 104 that support the chute/conduit 102, as well as system 100 generally, can be configured as structural steel frames with overall size and dimensions of a standard intermodal shipping container. For example, in an embodiment, each module 104 is 8′ wide, 9.5′ high and 20′ long and can be oriented with the long axis parallel to river flow. The modules 104 can be used as building blocks to assemble various structures, such as, the structural frames to support the conduit 102 and system 100. The modules 104 can be stacked on top of each other to a desired height and attached together, vertically and/or horizontally, with bolted structural connections or other fasteners. The modules 104 can also be used to build dam-module stacks, spillway-module stacks, and turbine-module stacks to assemble a modular hydropower installation. In an embodiment, each stack 105 of modules 104 is individually secured to a foundation on a streambed using a post-tension anchor, but each stack 105 is not secured or affixed to adjacent stacks 105. This independent stack configuration allows for easy modification, replacement, and maintenance of structures utilizing stacks 105. In an embodiment, a compressible gasket of neoprene or similar material can be used to seal all interface and contact points between modules 104, stacks 105, foundations and other interfaces or joints. The compressible gasket can be sized to be positioned between modules and interfaces on the downstream side of a particular structure.

In operation, initially modules 104 and stacks 105 of modules 104 can be arranged and secured at desired locations and heights to adjust the slope of the conduit 102 based on design specification requirements, topographical constraints, flow volume, flow rate, type of fish, etc. The conduit 102 can then be expanded and supported between the structural framework, and the baffles 106 can be installed and adjusted as desired along the length of the conduit 102 in each pool 103. Water entering the upstream end of the conduit 102 flows through the interconnected pools 103 via the baffle throughway 107 in each baffle 106. Fish entering the downstream end of the conduit 102 traverse the pools 103 and oncoming water in the opposite direction via the baffle throughway 107 in each baffle 106. Upon exiting the system 100, the fish are deposited upstream of the obstacle or barrier in the waterway.

FIGS. 1A-1C depict the conduit 102 extending linearly between endpoints; however, it should be appreciated that this depiction is for illustration purposes only. The system 100 is modular and the conduit 102 is made of flexible textile materials, so the system 100 can be adjusted to accommodate for modifications, topographical conditions, type of fish species, and site conditions. In other words, the conduit 102 can be expanded and arranged in various shaped paths along the site terrain, and modules 104 can be added to or removed from stacks 105 to adjust the slope and layout of the system 100. For example, pools 103 can be made larger or smaller by adjusting or replacing a portion of the textile fabric, the baffles 106 can be adjusted to increase or decrease the size of the baffle throughway 107, the chute/conduit 102 can be replaced with chutes/conduits 102 having different size to adjust for the overall width or depth of water. The entire system 100 can be disassembled, moved to another site, and reassembled.

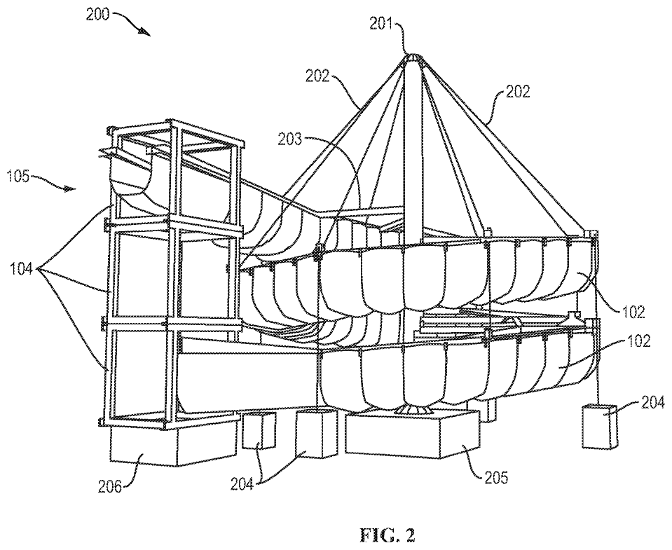

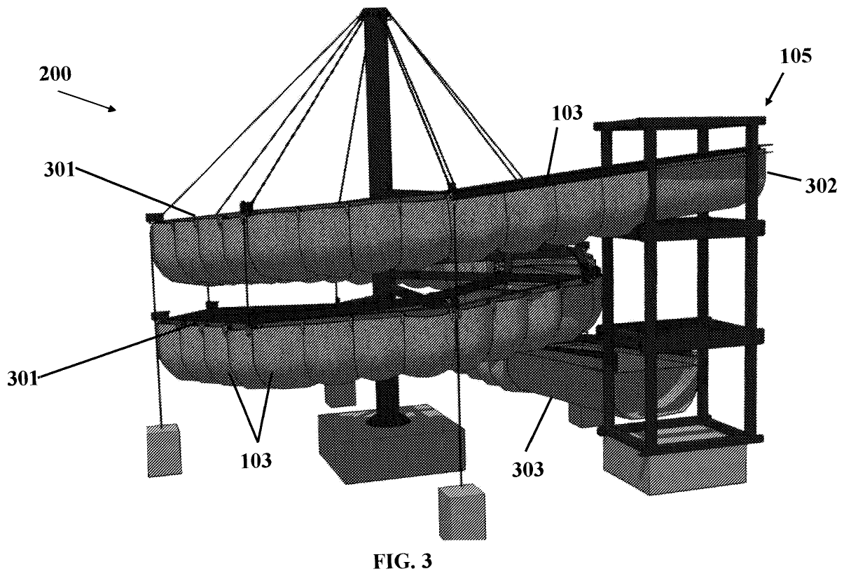

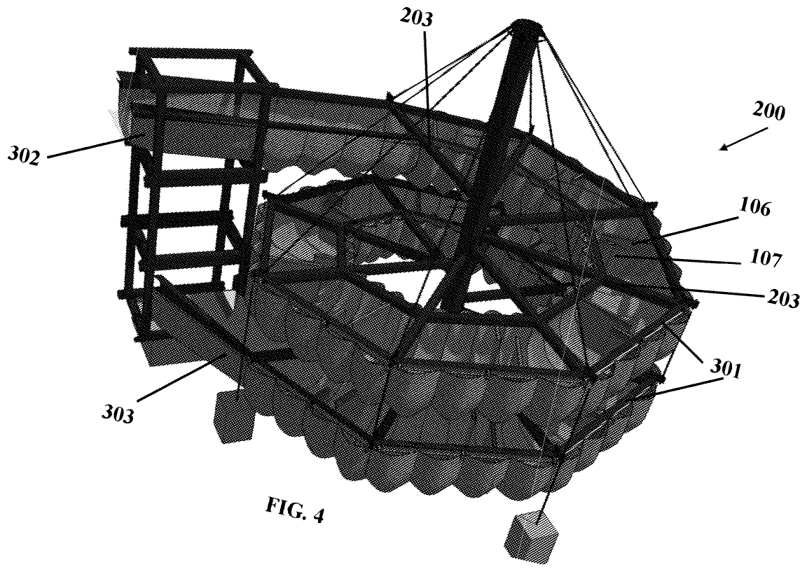

Referring to FIGS. 2-4, in another embodiment, an upstream fish passage system 200 can be installed in a spiral configuration that maintains a small footprint. Specifically, the flexible chute/conduit 102 can be spiraled into position about a central column 201 and supported in place by structural supports. In an embodiment, the fish passage 200 can include a center column 201 supported on a concrete footing 205, suspension tethers/cables 202, horizontal strut beams 203, ground anchors 204, stack footing 206, chute/conduit 102, pools 103, channel edge supports 301 for securing baffles 106, upstream end 302 of conduit 102, and downstream end 303 of conduit 102.

In one exemplary embodiment, the center column 201 is a 40 ft. tall, 12″ diameter steel pipe with ½″ wall thickness. It attaches to a concrete footing 205 roughly 11′×11′×4′ thick. A bolted connection is used so fasten the column 201 to the footing 205 so that the connection can be disassembled if necessary. The chute/conduit 102 can be 8′ wide and 5′ deep and capable of supporting water to a depth of 4.5′. The conduit 102 and baffles 106 can be supported and secured on the channel edge supports 301, which can be made of 8″ square steel tubing having about 0.375″ to 0.5″ wall thickness. The edge supports 301 are beams, i.e., loaded in flexure. The chute/conduit 102 is suspended from the center column 201 using suspension tethers/cables 202, which extend from the top of the center column 201 and attach to the channel edge support 301 and to horizontal strut beams 203. The suspension tethers 202 can be a ⅝″ diameter wire rope or solid rod. The horizontal strut beams 203 can be an 8″×8″ square structural steel tubing with ½″ wall thickness. The entire structure can be stabilized with ground anchors 204. Fish passage systems 100, 200 can be easily assembled, disassembled, and stored in a support module 104 during transport to other sites (see FIG. 1D).

In addition, many fishways include an auxiliary water pipe to provide attraction flows. The small footprint of the fish passage system 200 allows for an auxiliary pipe to be installed from the upstream end 302 of conduit 102 and extending down through the open center area of the spiral configuration. This water pipe can be made of flexible textile materials and can be detached along with the chute/conduit 102 and stowed for protection during high floods.

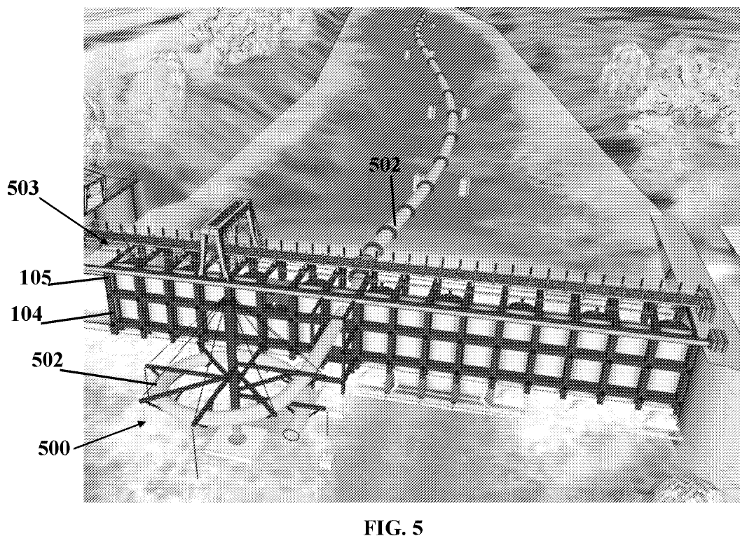

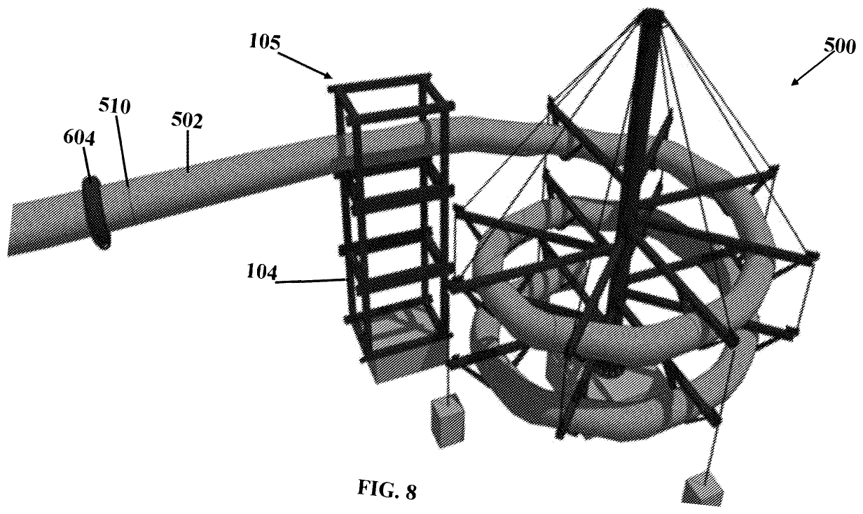

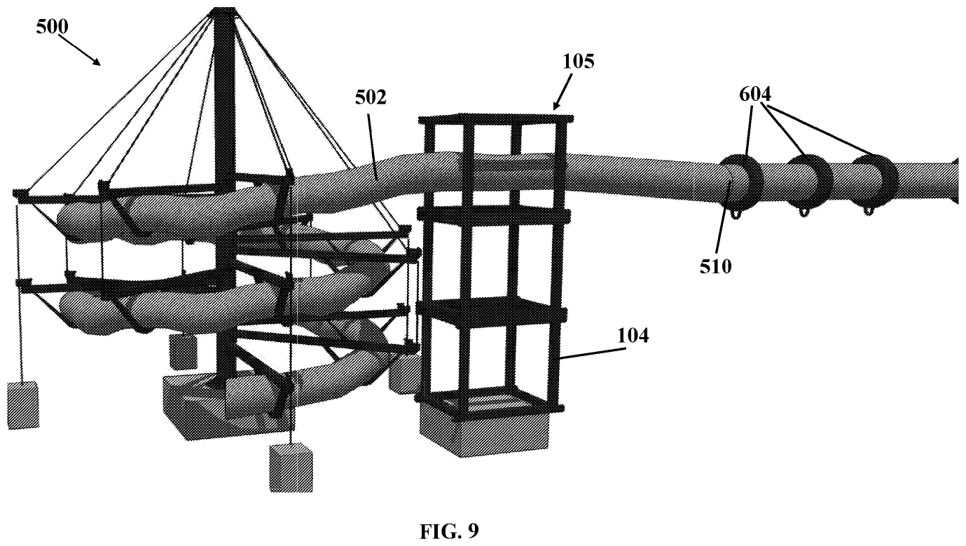

Referring to FIGS. 5-10, in another embodiment, a downstream fish passage system 500 can be positioned with a fish entrance 601 upstream of the dam and the exit end of the conduit 502 on the downstream side of a dam 503 with sacrificial connectors, such that, in an emergency overtopping event, the fish passage system 500 does not contribute to the structural load of the dam 503. The system 500 can include a conduit 502 configured as an enclosed tube along its length. As with embodiments discussed above, the conduit 502 can be made of textile materials. The conduit 502 can be propagated over and upstream of the dam 503. The dam 503 as illustrated in FIG. 5 is made of stacks 105 of modules 104; however, it should be appreciated that the fish passage system 500 can operate with any dam or river barrier regardless of what material (e.g., concrete, stone, wood) it is made of.

The fish entrance 601 of the conduit 502 can be releasably attached to a module 104 that is secured to a riverbed via a concrete footing 605 and a post-tension anchor. The fish entrance 601 can be oriented to face upstream so that fish traveling downstream can easily enter the conduit 502 via the fish entrance 601. The conduit 502 can include access ports 602 along its length that can be opened to remove debris and sediment, and to allow trapped air to escape. The access ports 602 can be made of textile materials. The conduit 502 can also include stiffening rings 604 along its length to retain the shape of the conduit 502 to keep the fish entrance 601 open. The stiffening rings 604 can be secured to the riverbed with mooring lines 603 and ground anchors 204.

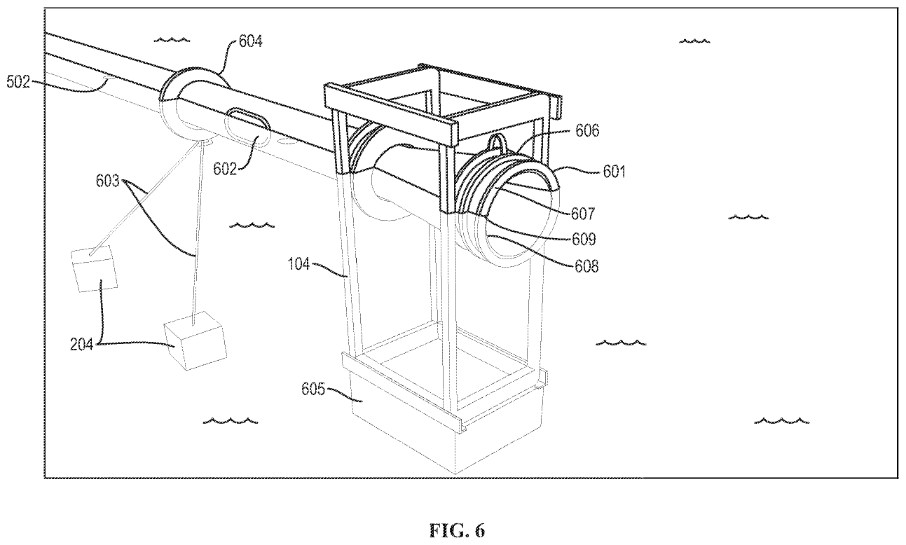

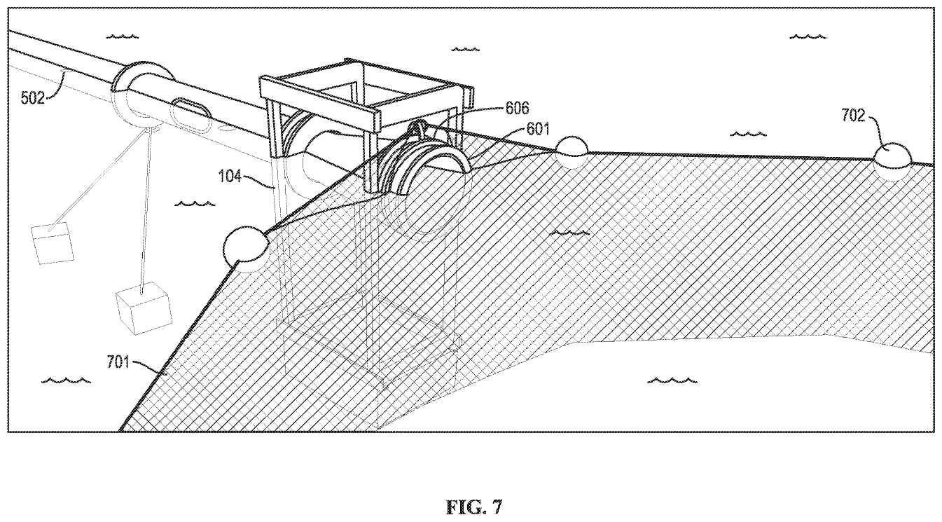

Certain species of fish, such as, Atlantic salmon smolts, American shad and blueback herring, swim near the surface. Therefore, the conduit 502 and fish entrance 601 can be positioned near the top of the module 104 to interact with migrating fish. Specifically, as shown in FIGS. 6, a top portion 607 of the conduit 502 and fish entrance 601 can be maintained above the water line 609, and a bottom portion 608 of the conduit 502 and fish entrance 601 can remain below the water line 609. Floats, such as, buoys 702, can be attached to the stiffening rings 604 and to a guide ring 606 so that the conduit 502 and fish entrance 601 “float” on the surface and move up and down with changing water levels. As shown in FIG. 7, in an embodiment, an extension net 701 supported by buoys 702 can be secured about the fish entrance 601 and surrounding area to funnel as many fish as possible into the conduit 502. In other embodiments, exclusion nets can be utilized to prevent fish or certain species of fish from entering the fish entrance 601 and conduit 502. In other embodiments, a pump can be utilized to generate flow near the entrance 601 to attract fish to the entrance 601.

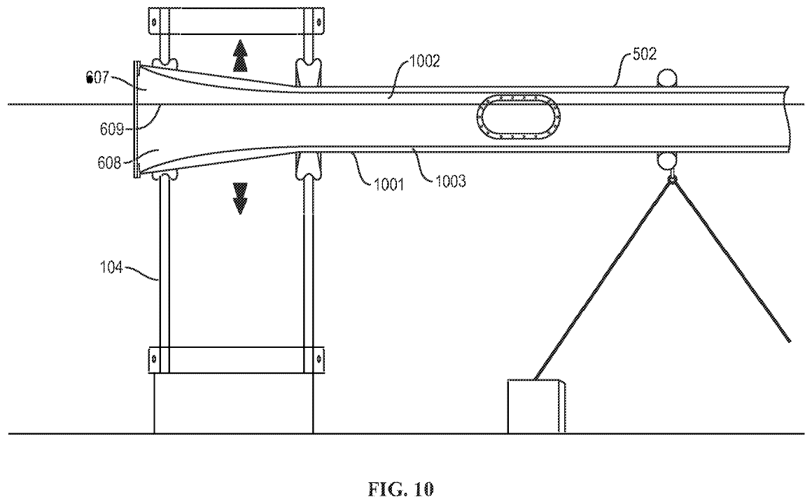

Referring to FIG. 10, the conduit 502 can further be configured to include a rubberized outer tube 1001 and a smart fabric inner tube 1002, both of which can extend along the entire length of the conduit 502. The inner tube 1002 can be made of flexible textile materials, and, in an embodiment, can contain embedded circuit and sensor components to monitor the environment within the conduit 502. An air bladder 1003 can be disposed between the outer tube 1001 and inner tube 1002 to increase buoyancy of the conduit 502. The air bladder 1003 can also extend along the entire length of the conduit 502.

With an ability to monitor the environment within the conduit 502, the fish passage system 500 can be modified to improve fish survival rates and reduce costs. Sections of textile materials comprising the conduit 502 can be inexpensively replaced or easily modified. For example, if reduced water flow through the conduit 502 is found to be acceptable, smaller diameter sections can be used, or existing sections can be pleated to make them smaller. In an embodiment, sections of textile material forming the conduit 502 can be attached to each other with rigid couplings and external stiffening rings.

### Independent Stack Modules & Seals for Modular Dams and Hydropower Facilities

Generally, as discussed above, the modules 104 can be used as building blocks to assemble prefabricated, modular systems for dams and hydropower facilities. The modules 104 can be stacked on top of each other to a desired height and attached together, vertically and/or horizontally, with bolted structural connections or other fasteners. Modules 104 can be utilized to build dam-module stacks, spillway-module stacks, and turbine-module stacks to assemble a modular hydropower installation.

In an embodiment, each stack 105 of modules 104 can be configured to be structurally independent by ensuring that there are no structural connections between adjacent stacks 105. In other words, each stack 105 can be individually secured to a foundation on a streambed using at least one post-tension anchor, but each stack 105 is not secured or affixed to adjacent stacks 105. This independent stack configuration allows for easy modification, replacement, and maintenance of stacks 105 individually.

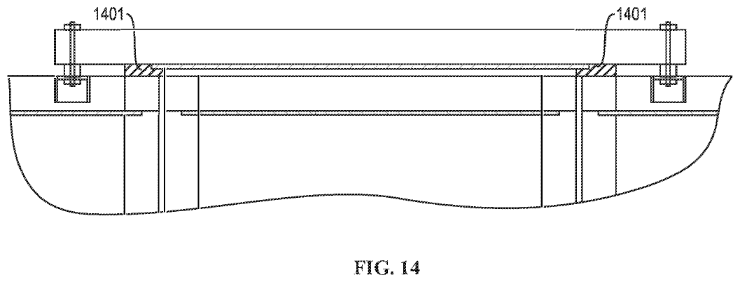

Referring to FIGS. 5 and 11-15G, each module 104 in a stack 105 can be structurally and mechanically connected to a module 104 above or below it and to a stream bed at the same time by a post tension anchor 1202. In an exemplary installation process, the post tension anchor 1202 can be installed by first drilling a hole below grade, flushing all cuttings from the hole, preparing the subgrade for placement of the modules 104, then installing the subgrade portion of the anchor leaving a portion protruding above grade. The next step can be to grout the bond length. After the grout has cured for 4 days minimum and reached a target grout strength of 4,000 psi, the modules 104 can be placed in the stack 105 and using an appropriate coupler bar length can be added to the post tension anchor 1202, so that it can be passed through each module 104 in the stack 105 and post tensioned using an incremental lock off sequence against an anchor head assembly 1203 or other fastener. In an embodiment, shear connectors can also be utilized to prevent individual modules 104 from sliding off the module above or below it. Each stack 105 can be structurally attached and secured to a foundation 1204 on a riverbed using the post tension anchor 1202. A shear key can be coupled to the concrete slab supporting the stack 105 to prevent the stack 105 from sliding in an upstream or downstream direction. A grout bag can be inserted between the base module of the stack 105 and the concrete shear key to secure the stack 105 in place. The grout bag can be broken up and removed when the stack 105 is removed and replaced.

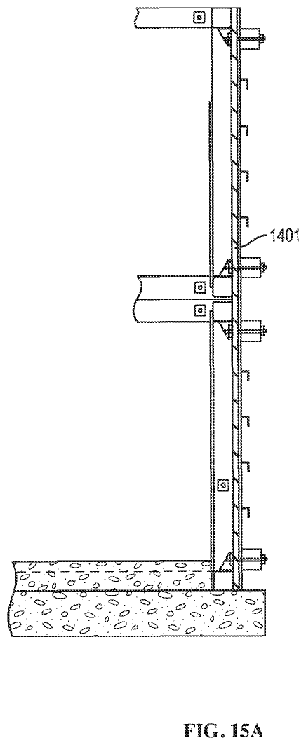

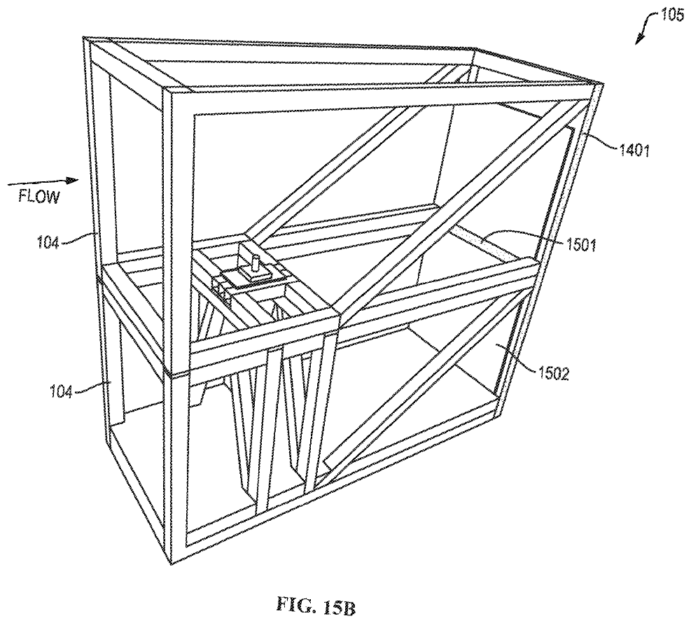

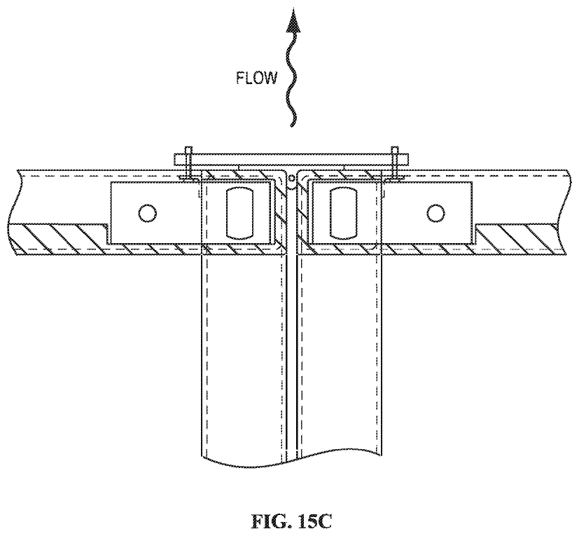

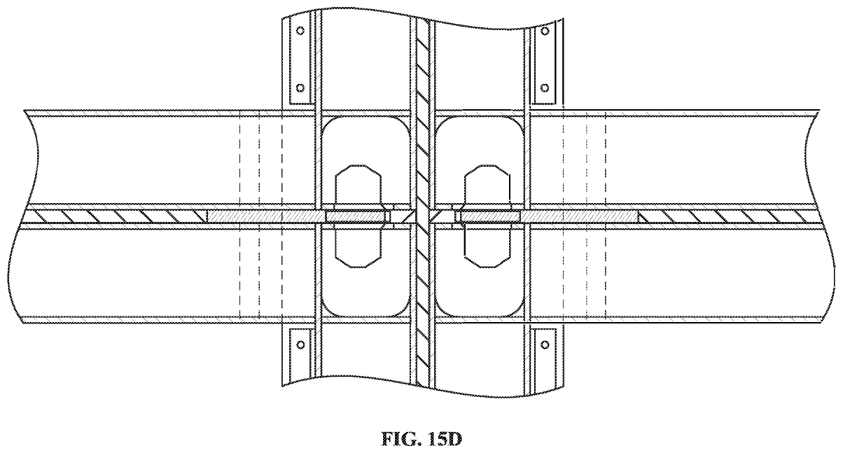

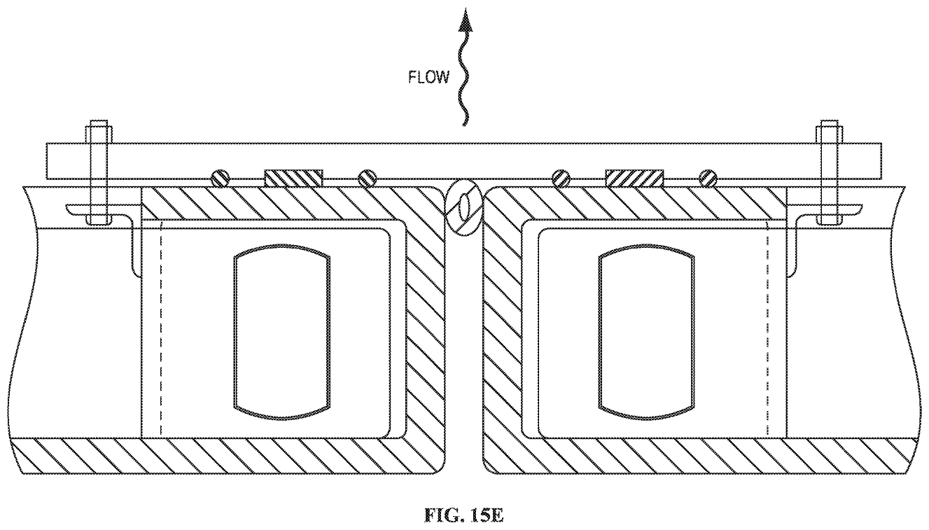

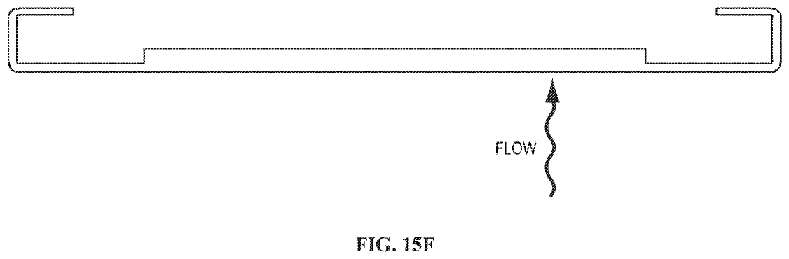

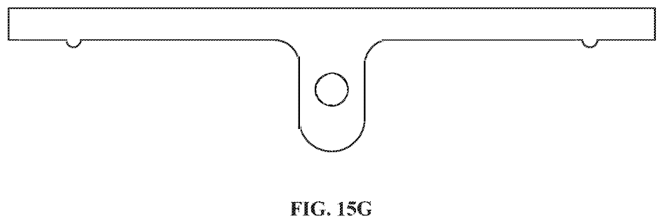

In an embodiment, each stack 105 can include vertical seals 1401 that can be installed vertically on the downstream side between adjacent stacks 105 to prevent leakage and provide a water-tight connection. Similarly, horizontal seals 1501 (see FIG. 15B) can be installed horizontally between the individual vertically-stacked modules 104 that form a particular stack 105. In an embodiment, the seals can be configured as compressible gaskets and sized to be positioned on vertical interfaces on the downstream side of the stacks 105 and on horizontal interfaces between modules 104 of a stack 105. In an embodiment, the horizontal seals 1501 can also be positioned between the stack 105 and its foundation and other interfaces. The seals 1401, 1501 can be made of neoprene or other suitable material. For example, in various embodiments, seals can be made of Adeka KBA-1510 FP, water-resistant soft neoprene O-ring cord stock, ASTM D-2000 1BC408/508/609/710/SAE J200.

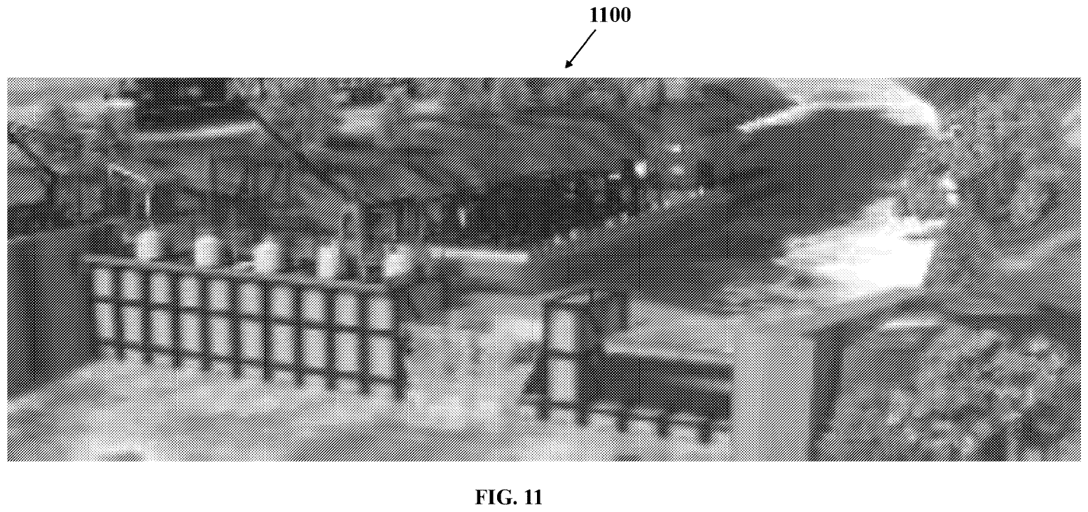

Referring to FIGS. 11-13B and 16-18B, an exemplary small standardized prefabricated module hydropower (SSPMH) facility 1100, 1800 with foundation, generation and passage modules is illustrated. The SSPMH components can be included in a kit of prefabricated components that can be assembled on-site. In an embodiment, the building block modules 104 of the SSPMH facility can be manufactured in the form factor of 20-foot high-cube multimodal shipping containers—including standard attachment points such as slotted corner blocks—for low-cost transport by truck, rail or container ship. They can be configured to suit the specific characteristics of the site. In many cases, cofferdams or diversions can be eliminated or significantly reduced as part of the installation process.

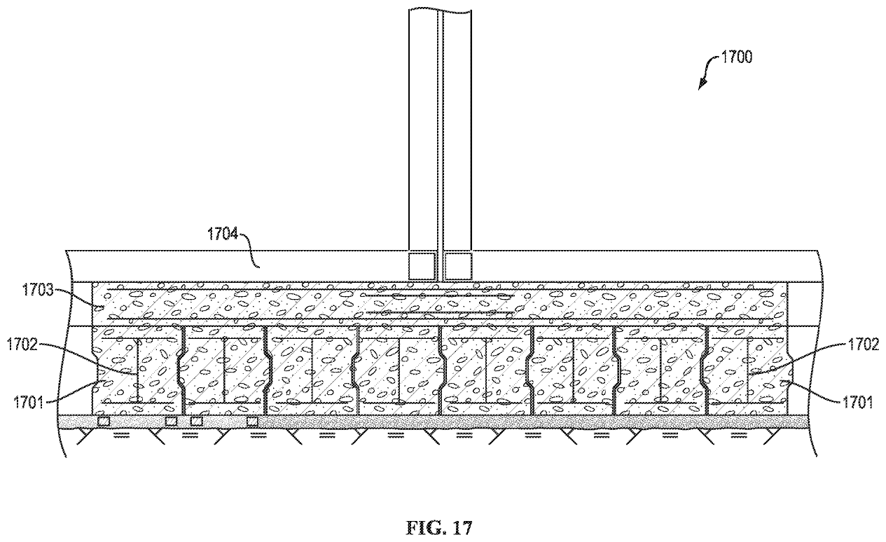

As shown in FIG. 17, a foundation structure 1700 can be utilized to support a SSPMH system 1100, 1800. The foundation structure 1700 can include multiple interlocking concrete segments/planks 1701 and each segment 1701 can be reinforced with an I-beam 1702. The concrete segments 1701 can be prefabricated and modular so that they can be assembled onsite. In an embodiment, each concrete segment 1701 can be precast at a size of approximately 2′×2′ square and 36′ long. The concrete segments 1701 can be laid side-by-side in the streambed and oriented so the interlocking joints and the long side of each segment/plank 1701 run parallel with the flow of water.

The foundation structure 1700 can further include a single or series of prefabricated, transverse reinforced concrete slabs 1703 that can be positioned on top of the concrete segments 1701. In an embodiment, the concrete slab 1703 can measure 1′×4′×8′. In various embodiments, multiple transverse concrete slabs 1703 can be stacked at different orientations to accommodate a desired design or specification. For example, two slabs 1703 can be stacked with each having, for instance, a 90 degree difference in orientation. In an embodiment, sockets can be precast into the concrete segments/planks 1701, and the slabs 1703 can include a sleeve and bolt that is used to connect and tension the planks 1701 and slabs 1703 together.

Prior to installing the foundation structure 1700, initial preparatory steps include removing loose, compressible and organic streambed materials to reach competent soil or bedrock, leveling the soil or bedrock, using chair jacks to level the base planks and then filling in with grout. Grout cures faster than concrete, has limited leaching compared to cast-in-place concrete, can cure in the wet, and has been approved by the Federal Energy Regulatory Commission to arrest seepage.

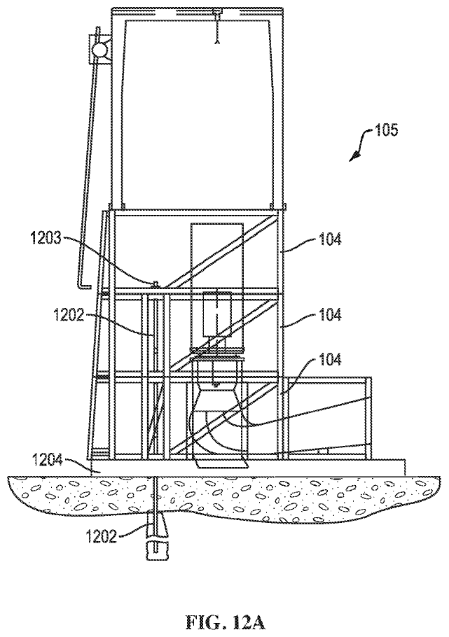

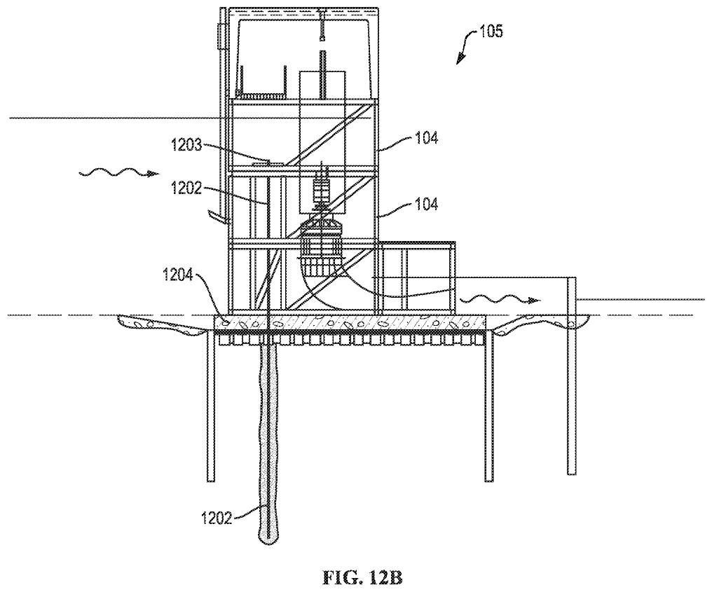

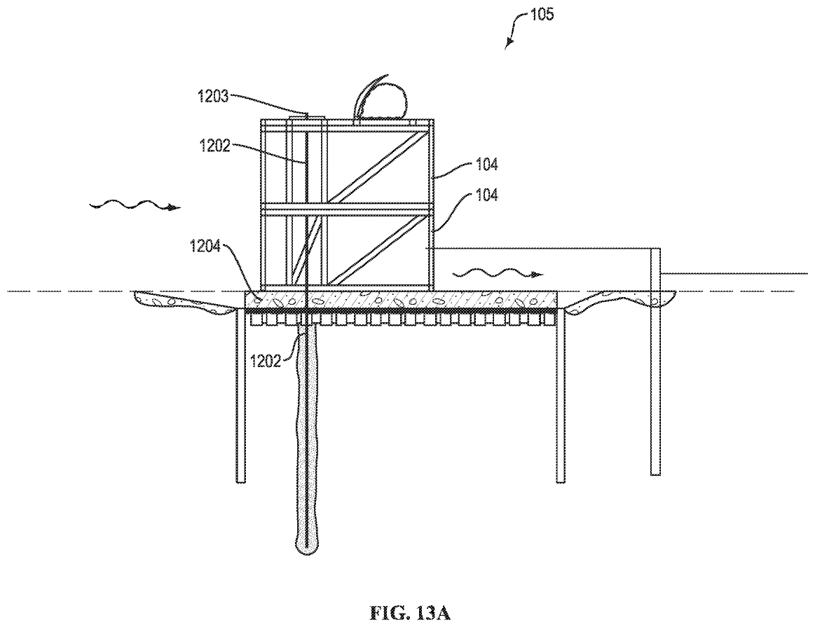

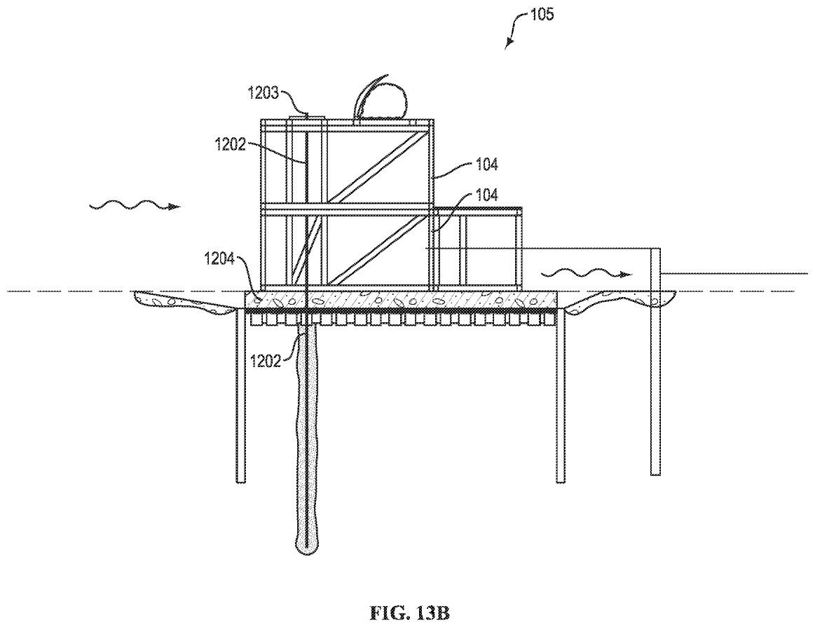

The foundation structure 1700 can also include a foundation base module 1704 that can be configured, in an embodiment, as a 8′ wide×20′ long×9.5′ high structural steel base module. The foundation base module 1704 is positioned against the transverse concrete slab 1703, buy in some embodiments, a seal can be positioned between the base module 1704 and the slab 1703. Additional modules 104, such as a second or third module 104, can be stacked on top of the base module 1704 to achieve a desired height. Each stack can be oriented with the long dimension parallel to local flow of water. A water-retaining bulkhead 1502 can be affixed at the downstream face of the module stack 105. This configuration of the bulkhead 1502 affixed to the downstream face of the stack 105 allows the water to enter the modules 104 of the stack 105, and the weight of the entering water stabilizes the stack 105. Each stack 105 can be used to house systems such as turbine/generators, water release gates, etc., to create generation and passage modules (see FIGS. 12A, 12B, 13A, and 13B) for the SSPMH facility 1100, 1800.

Each stack 105 in the SSPMH system 1100, 1800 can be tied into the riverbed through the foundation with, for instance, via a 3-inch diameter high strength steel rod that can be used as a post-tensioning anchor. The above-ground portion of the post-tension anchor can be extended with a coupler to capture and secure the intermediate and top modules 104. The post-tension anchor can be post-tensioned to a preload of approximately 600 kips and locked off against the top module frame to greatly increase downward force at the foundation interface and achieve the minimum factors of safety requirements for sliding, overturning, and uplift stability. The addition of a large knife valve or slide gate to the water-retaining bulkhead 1502 at the bottom of the foundation base module 1704 allows it to serve for low water passage and/or sediment passage.

Another benefit of utilizing knife valves or slide gates is they allow assembly in the wet without requiring any separate cofferdam or water control bypass systems. In simplified terms, the in-the-wet construction sequence is to first install the upstream and downstream sheet piles on one half of the river, and install an additional sheet pile line near the middle of the river in an orientation perpendicular to the first two lines of sheet piles and parallel to the river flow to bound the first working area. Water can be allowed to flow uninterrupted through the second half of the river, while the modules 104 are assembled in the bounded half. Once the assembly is complete, the knife valves or slides gates are left open and the sheet piles are cut down to the riverbed. Water begins to flow through the open structure. The process is repeated on the second half of the river. Once the entire modular facility is constructed appropriate knife valves or slide gates can be closed and the facility can be taken to operational status.

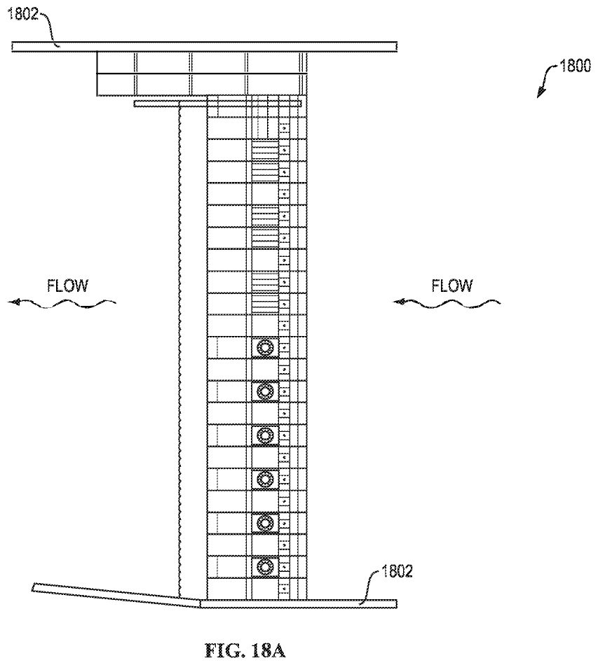

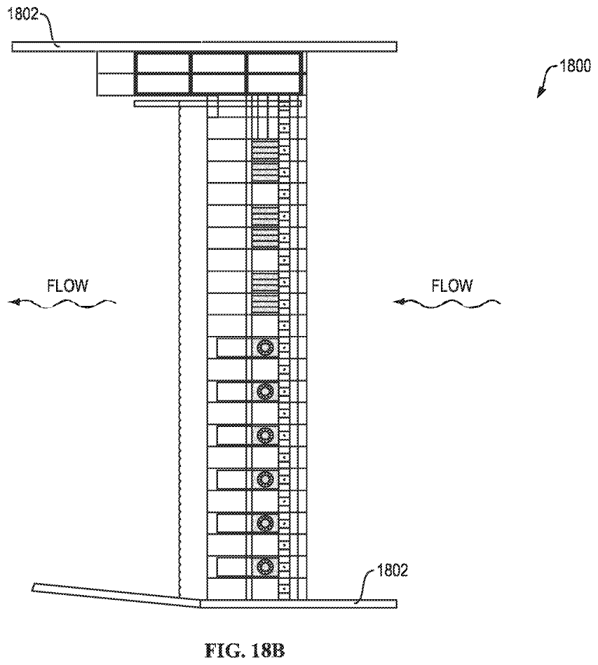

In an embodiment, abutment walls 1802 (in FIGS. 18A and 18B) can be implemented and can include a precast modular concrete retaining wall system, which provides vertical faces to interface with the ends of the module line on the inboard sides and to tie into the existing streambank topography on the outboard sides. An abutment system 1802 can include modular concrete units including a vertical concrete face panel attached to a single or double counterfort stem capable of creating upstream, downstream, and channel side abutments on both sides of a watercourse. The wall units can be stacked to create a tapered cross section with the longest stems at the bottom to develop a monolithic gravity block with a wide base for stability. Select backfill between the stems provides the mass for the wall and interlocks with the stems. Commercially available precast concrete wall systems of this type can be suitable for this application. At sites where overburden is present and it is impractical or uneconomic to excavate to bedrock, a modular retaining wall system is installed in conjunction with driven steel sheet piles extending both upstream and downstream of the foundation interface and into the abutment slopes for seepage control.

A generation module stack (see FIGS. 12A and 12B) can include an intake, turbine, generator, and outlet. It can include a base module that contains a preinstalled draft tube, a middle module with a seating plate for the turbine, and a top module with guide rails for a sliding cylinder gate to open the turbine intake. In general, a generation module stack can be placed adjacent to a foundation base module 1704 to ensure approach velocity at the intake stays below 2 fps. The turbine/generator units can be swapped out with the overall dam in “semi-hot” status—meaning that the other turbines continue to operate—and the cylinder gates are opened and shut via a gantry crane that travels along the top of the dam. The gantry crane also controls the lateral motion of a trash rake, which is attached to its upstream side. (See FIGS. 12A and 12B).

A water passage module stack (see FIGS. 13A and 13B) an include a base and intermediate module with a flat top module that can include a bottom-hinged pneumatically operated crest gate. It can also be modified to serve as a surface by-pass (downstream) fish passage.

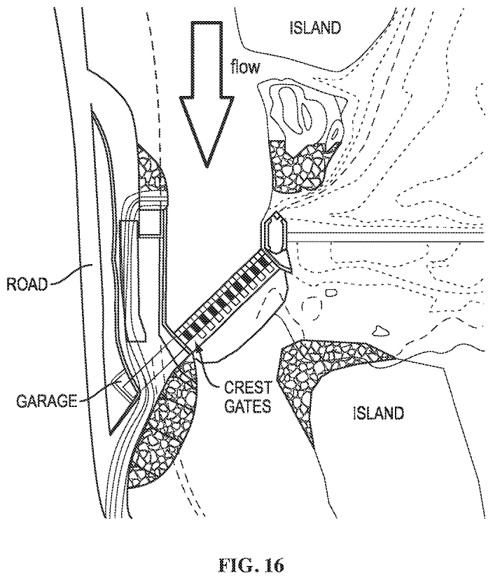

The SSPMH system 1100, 1800 can be designed around the principle of exclusion—that is, no fish are passed through the turbine runners—so as to avoid entrainment issues altogether. The modular powerhouse can be rotated to give rise to headpond flow diagonal to the turbine intakes and an approach velocity at the trash rack of under 2 fps. In this way the downstream fish migrants continue straight downstream and avoid the turbines altogether. At the downstream end of the powerhouse another module can be used to safely pass the fish (see FIG. 16).

Overall stability of the system can be enhanced by utilizing the post-tensioned anchor to substitute for the mass of a traditional dam section. Typically, a dam relies on a substantial mass of concrete or earthen material to create a load normal to the foundation interface sufficient to engage enough friction to prevent the dam from sliding downstream due to the hydrostatic loading from the impoundment. The SSPMH system's modules 104 can be specifically designed to be relatively lightweight; therefore, another means can be used to resist sliding at the foundation interface, overturning and uplift. This stability is accomplished through the use of a tie-down anchor, which is bonded via grout to the foundation and locked off against the top module. The anchor assembly essentially squeezes the container-modules against the foundation.

The dam/foundation interface is important for dam stability; it provides surfaces with a high coefficient of friction to resist sliding, and appropriate stiffness to prevent differential settlement as between different parts of the foundation. The concrete segments/planks 1701 can be cast with a texture so as to maximize friction. Stiffness is obtained by the use of two layers of precast concrete planks connected with torqued slip-critical tension rods to obtain monolithic action.

The modules 104, 1704 themselves can be fabricated from 50 ksi hollow structural sections (HSS). The installation procedure can be summarized as follows. First, the foundation can be anchored on a coarsely leveled, competent subbase consisting of bedrock or coarse-grained soils. In either instance, for a low risk, safe installation the subbase area will need to be dewatered and prepared to receive the foundation's concrete segments/planks 1701. De-watering half the stream course at a time will allow preparation of the one half of the subbase in the dry and continuous stream flow around the dewatered half. The next step depends on riverbed conditions.

If the site is underlain by coarse-grained soils, the subbase is dewatered by driving interlocking steel sheet piles through these soils to refusal or bedrock. The piles extend from the upstream bank to the downstream bank in semi-circular fashion and extend high enough to prevent water from entering the dewatered area under normal flow conditions. Once the area has been prepared and the foundation base modules anchored in place, the piles are cut nearly flush with the bottom of the stream to return it to its full width. The portion of the piles that remain embedded in the coarse soils act as a barrier to minimize seepage beneath the foundation. This approach avoids the extra costs of a separate cofferdam. The opposite half of the stream course undergoes a similar process as above to prepare the remaining subbase. Low level outlet gates installed in the base container-modules of the first phase of construction are opened to pass the diverted stream flow through them.

If the site is underlain by bedrock, it is not possible to dewater the site using sheet piles. Instead, one half of the stream course may be dewatered using flexible intermediate bulk containers (FIBCS) filled with sand and installed in a semi-circular fashion. If necessary, steel plate can be sandwiched between the FIBCS to provide additional seepage control. The FIBCS are removed following placement of the first phase of modules and the process repeated on the opposite bank.

Either of the above construction processes ensures continuous flow of the stream course during construction and has minimal environmental impacts. In both instances, once both halves of the foundation base modules have been installed, the remaining assembly activities are performed with the stream course flowing normally through the low level outlets.

A water passage module stack (see FIGS. 13A and 13B) can be configured in multiple designs. For example, as a 5.2-foot gate for up to 275 cfs conveyance and as a 12-foot gate for up to 1,000 cfs conveyance.

Typically, there will be some sediment buildup in the headpond, even in a pure run-of-the-river installation. Sediment can be passed at the base of each foundation base module 1704 through a water control element in the form of a knife valve or slide gate. An outlet orifice will be provided in the downstream bulkhead 1502 of each dam stack.

Periodic and programmatic opening of the gate under normal pool conditions will result in flow velocities to effectively flush sediment downstream to prevent erosion further downstream as well as for spawning. Periodic sluicing, flushing, or venting would maintain the bulk sediment transport regime averaged over the time between periodic sluicing/flushing/venting events.

With regard to constructing a prefabricated modular hydropower facility using shop-built components, the data that should be ascertained is the profile of the top 20-30 feet of geologic strata underneath a riverbed. Toward this end, the riverbed can be digitally profiled, and the foundation components can be pre-shaped using 3-D printing or computer controlled hot knife sculpting of polystyrene or other means to make mold inserts replicating the localized topographic conditions that the foundation blocks need to mate with. The precast elements can be sealed against the foundation, and in some cases, to shape the foundation. This technique may reduce the amount of site preparation and construction impact required to receive the modules and eliminate or reduce the need for chair jacks and the plank-leveling process steps.

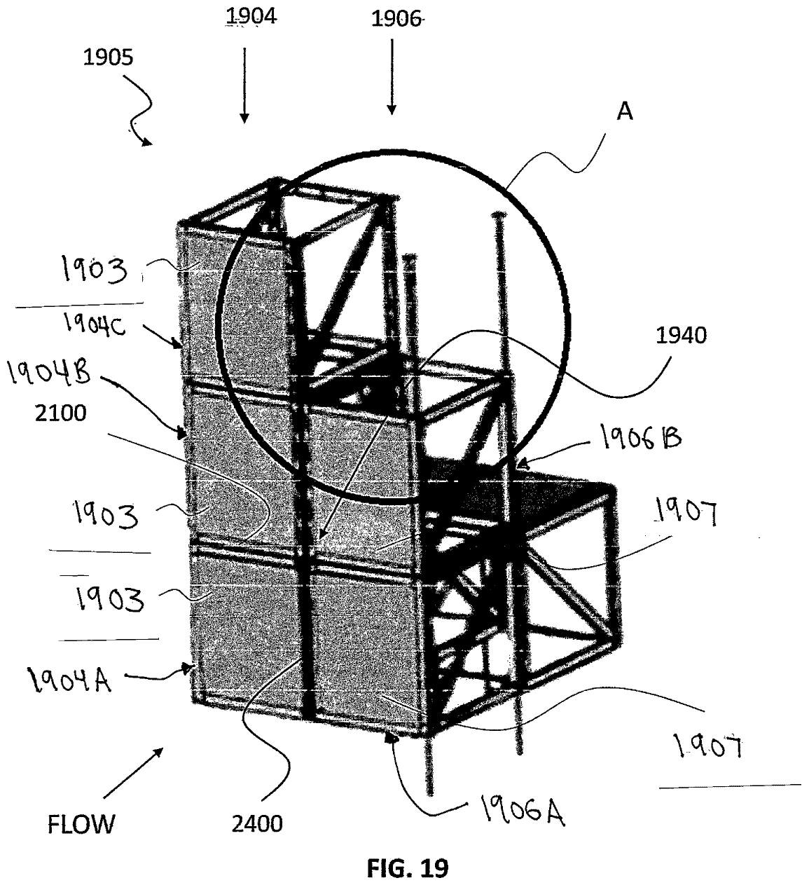

FIG. 19 is a perspective view of a module stack assembly 1905 in accordance with an embodiment of the present invention. The module stack assembly 1905 includes two vertical stacks 1904, 1906, each stack 1904, 1906 having a plurality of modules. For example, vertical stack 1904 includes a bottom module 1904A, a middle module 1904B, and a top module 1904C. Vertical stack 1906 includes a bottom module 1906A and a middle module 1906B. While each vertical stack 1904, 1906 can have two or three modules, it is understood that there can be more or fewer modules. Similarly, while only two vertical stacks 1904, 1906 are shown, there can be more vertical stacks in a module stack assembly. In some embodiments, the modules can be integrated using materials and methods described above, or those in subsequent figures as will be described in more detail below.

In FIG. 19, water flows from left to right as indicated by the arrow. As discussed above and shown in FIG. 15B, a module stack 105 can include a water-retaining bulkhead 1502 on the downstream face of the stack 105. Similarly, in one embodiment, the module stack assembly 1905 of FIG. 19 can include water-retaining bulkheads 1903 and 1907 (i.e., on modules 1904A/1904B/1904C and 1906A/1906B, respectively) similar to that shown in FIG. 15B, except that the water-retaining bulkheads of the module stack assembly 1905 may be disposed on the upstream face of the module stack assembly 1905.

An important function of the module stack assembly 1905 is to retain water to the necessary head elevation so the water may flow through the turbines in the module stacks as disclosed herein. It is important that the module stacks 1904, 1906 do not allow too much water to pass through the junctions where the modules come together and other mating locations, so the water is available to flow through the turbines and generate power. One characteristic of the invention that helps to prevent leakage is that the bulkheads 1502, whether on the downstream face as in FIG. 15B or on the upstream face as discussed in FIG. 19, are welded to the frame elements making a water-tight connection. As a result, the most significant potential leakage paths are through the junctions where the individual modules come together. For example, there are vertical seals 2400 where two side-by-side modules 1904A, 1906A come together, horizontal seals 2100 where two modules 1904A, 1904B stacked on top of each other come together, and a quad point 1940 where the corners of four modules 1904A, 1904B, 1906A, 1906B come together.

In one embodiment, a module stack assembly includes two vertical stacks where each vertical stack includes at least two modules. Seals similar to those discussed above may be horizontally installed between or covering over the junction between two vertical modules or vertically installed between or covering over the junction between two horizontal modules. The seals are configured to span across either horizontal or vertical joints between the modules, but not both. Thus, for two vertical stacks each with two modules, there may be three seals: two discrete horizontal seals, one each along the horizontal junction between each of the top and bottom modules, and one single vertical seal both covering the vertical junction and extending into the vertical junction, for example shaped like FIG. 15G. This configuration seals the horizontal and vertical junctions as well as a quad point about a center where the four modules come together. In some embodiments, similar seals (not shown) may be utilized between the bottom modules 1904A, 1906A and a precast concrete foundation structure 1700 similar to that shown in FIG. 17, or against a cast-in-place foundation slab.

In one embodiment, the three seals of the module stack assembly are configured to resist water leakage between the horizontal joints and the vertical joints such that the assembly 1905 has a leakage rate of much less than about 0.073 gpm per linear foot of seal, as evidenced in testing described below and as shown in Table 1 in the cell corresponding to the last row and second to last column.

In various embodiments, the modules are made of cast-in-place concrete with or without bar or fiber reinforcement. In various embodiments, the modules are made of precast concrete with or without bar or fiber reinforcement. In various embodiments, the modules are made of steel alloy, aluminum alloy, glass fiber reinforced plastic or carbon reinforced plastic. In various embodiments, the modules are made of a hybrid or combination of any two or more of the above materials.

In operation, the modules need not be completely watertight. There are no established engineering association standards for calculating leakage through modular dams at hydropower facilities. However, there is some guidance in the American Water Works Association for Fabricated Stainless Steel Slide Gates (AWWA C561) and for Fabricated Case Iron Slide Gates (AWWA C560) specifications. These specifications state that with respect to seating head for these gates, leakage shall not exceed 0.1 gpm of leakage per linear foot of seal. Applying this specification to an SSPMH facility results in a barely perceptible impact on power generation as shown in the following calculations.

Assumptions: (a) leakage at all seals shall not exceed 0.1 gpm per lineal foot of seal, (b) calculation based on a three-module stack such as shown in FIG. 19, where each module is 8 ft wide and 9.5 ft high with a total stack of 28.5 ft in height (assuming height added by the seals to be negligible), (c) normal pool is 2.2 ft from top of the module stack, (d) calculate leakage for a single stack, (e) calculate leakage for sealed joints only, i.e., do not include seepage through the foundation and (0 calculate for a turbine design flow of 100 cfs. This capacity represents a small turbine and will provide a conservative estimate of the impact of leakage on power generation. For reference, a typical turbine for a SSPMH facility 1800 has a hydraulic flow capacity in the range of from about 200 cfs to about 500 cfs.

Calculations: (a) seal joint location and wet length—(i) module stack side-to-side vertical joint (one side), length=28.5−2.2=26.3 ft, (ii) module-to-module top-to-bottom horizontal joint, length=8 ft per joint×2 joints=16 ft, (iii) bottom module to foundation horizontal joint, length=8 ft and (iv) total wet seal length=26.3+16+8=50.3 ft; (b) total leakage at seals per stack—(i) total leakage=total seal length×unit leakage=50.3 ft×0.1 gpm/ft=5.03 gpm per module stack and (ii) 1 cfs=448.8 gpm, 5.03 gpm×1 cfs/448.8 gpm=0.0112 cfs, resulting in leakage rate of about 0.0112 cfs per stack.

Significance of leakage with respect to power generation: (i) assume a hydropower facility made up of 21 module stacks including 9 stack assemblies with a turbine generator, (ii) leakage of about 0.0112 cfs per stack assembly×21 stacks=0.235 cfs for the facility, (iii) hydraulic flow through the turbines for power generation is 9 turbines×100 cfs/turbine=900 cfs, (iv) leakage impact on generation flow=leakage/hydraulic capacity=0.235 cfs/900 cfs=0.000261, i.e., 0.026%, and (v) in the case where the hydropower project could tolerate 0.1% of generation flows being lost to leakage, then a leakage criterion of 0.1/0.026×0.1 gpm/ft=0.385 gpm/ft would be acceptable.

The calculation above includes leakage at seals, not through the modules, since the modules fabricated as described herein are unlikely to contribute to leakage. For modules where the structural framework 104 is fabricated from structural steel with welded bulkheads 1502, the welded joints are a potential source of leakage. In some embodiments, the seams and joints may be seam welded by certified welders, and in accordance with the latest standards of the American Welding Society (AWS) and American Institute of Steel Construction (AISC). In addition, one or more of the inspection techniques may be utilized, including 100% visual inspection, air pressurize bubble test with soap spray, or water spray test for liquid-tight welds. As a results, leakage through the framework 104 or bulkheads 1502 for a welded steel assembly is not a significant source of leakage. All or part of the structural framework 104 and bulkheads 1502 could be fabricated from structural fiber reinforced plastic (FRP) composites using glass, carbon, aramid or any other suitable structural fiber or hybrids of various fiber reinforcements for hydropower projects where FRP corrosion resistance and strength to weight ratios are a benefit warranting the extra cost. For example, in projects located in brackish water or in remote locations where weight driven transport costs are significant. Composites are known to absorb water in the polymer resin matrix, but it is an insignificant amount with respect to leakage especially if fabricated to water storage standards such as, for example, BS EN 13280:2001 “Specification for glass fiber reinforced cistern of one-piece and sectional construction, for the storage, above ground, of cold water.”

In some embodiments, the modules could include precast concrete elements such as ground anchors 206, the foundation elements shown in FIG. 17, the bulkheads 1502 and all or part of the framework 104 could be made of precast concrete. Concrete is a porous material, thus, as the concrete cures and the water evaporates it leaves behind a network of pores, some of which are interconnected providing a pathway for moisture ingress. However, construction grade concrete with compressive strength of at least 4500 psi after 28-day cure is nearly impenetrable. Professional civil engineers when performing general seepage calculations use a hydraulic conductivity value of 10 E-09 cm/sec as a conservative estimate for concrete. If the concrete develops cracks, however, pathways can open up for some leakage. Fiber reinforced concrete is a form of concrete that includes high strength fibers that are known to delay the onset of cracks in concrete and to bridge cracks keeping them from opening up when they occur. For example, steel fibers on the scale of 0.01 inches in diameter and ¾ inch long making up about 2% of the concrete mix are effective (see US Army Corps of Engineers report: Hoff, G. C., 1975, “Use of Fiber-Reinforced Concrete in Hydraulic Structures and Marine Environments,” Paper C-75-4). And for example, glass fibers on the scale of 0.0006 inches in dimeter by about ½ inch long making up 0.1% of the mix volume have been demonstrated to increase the flexural strength of concrete by about 20% (see Dayalan J., 2017, “A Study on Strength Characteristics of Glass Fibre Reinforced High Performance-Concrete,” Int. res. J. Eng. Tech. v04, p2395).

The junctions where modules come together are the prime locations for leakage in modular dams and hydropower facilities. Sealing these joints in a way that the modules can be disassembled for repair, replacement or reuse at the same or different site is not a simple manner of neoprene gaskets. There are some specific seal material properties, relative dimensions and placements that make for successful low leakage modular dam and hydropower facility.

The seals between the modules and between the modules and the foundation are specified to meet certain leakage criteria. Testing apparatus and testing methods that can be used to verify the performance and provide test data to define a range of material properties and relative geometry for successful non-leakage performance will be described further in more detail below.

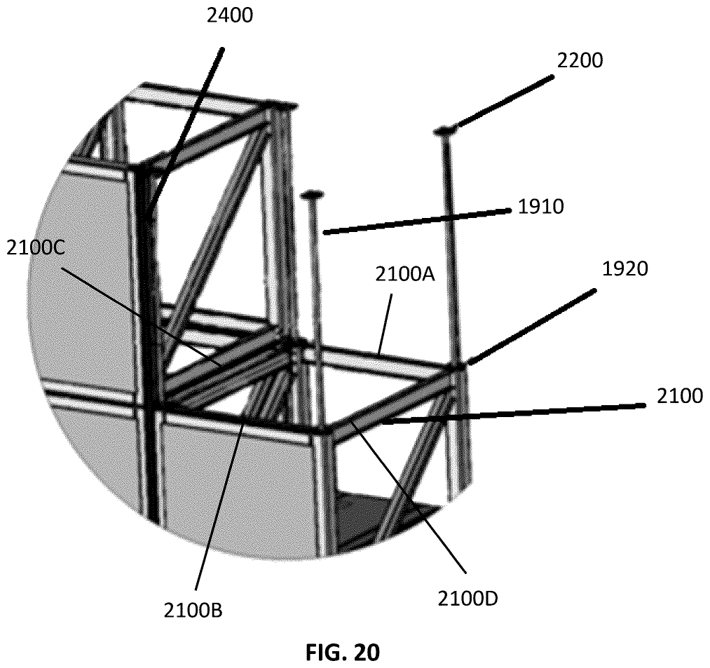

FIG. 20 is a close-up of a portion (represented by circle A) of the module stack assembly 1905 of FIG. 19. As shown, one of the top modules 1906C has been removed to better illustrate the internal parts for integrating the module stacks 1904, 1906 and preventing leakage. In some embodiments, the integration and leakage prevention parts can include one or more of the following: module integration rod 1910, male end cap 1920, horizontal seal 2100, female end cap 2200, and vertical seal 2400.

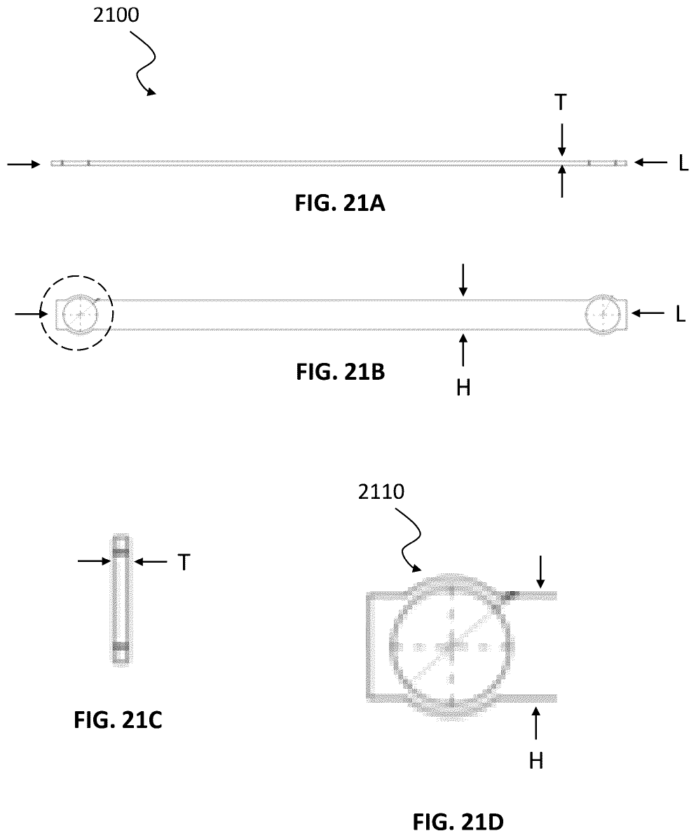

FIGS. 21A-21D are top and side views of a horizontal seal 2100 according to one embodiment of the present disclosure. As shown in FIG. 19, horizontal seals 2100 may be placed on the upstream top horizontal surface of the frame structures of each of the bottom modules 1904A, 1906A that mate with the corresponding middle modules 1904B, 1906B. Similarly, horizontal seals 2100 may be placed on the upstream top horizontal surfaces of the frame structures of each of the middle modules 1904B, 1906B that mate with the corresponding top modules 1904C, 1906C (not shown). For example, the horizontal seals 2100 may be placed on the steel beam 2100B that run perpendicular to the flow. To achieve the low-leakage rates described above it is not necessary to place any seals on the downstream beam 2100A or on the steel beams 2100C, and 2100D that run parallel to the flow. The vertical seals 2400 may be a combination seal that both fills the upstream vertical gap and covers over the upstream vertical gap by using a shape such as shown in FIG. 15D. The vertical seals 2400 may be installed by tapping or pressing the protruding bulb into the vertical gap with the aid of a soap solution as a lubricant, and pressing the flange up against the upstream surface of the module frame on either side of the vertical gap, so that it covers the upstream side of the vertical gap between two stacks including the quad-point. The vertical seal may be on continuous seal from the bottom of the stack to the top of the stack or may be in sectional lengths so long as the sectional lengths are installed such that the vertical seal spans the quad-point.

FIG. 21A is a top view of a horizontal seal 2100 according to an embodiment, FIGS. 21B and 21C are side views of FIG. 21A, and FIG. 21D is a close-up of a portion (represented by dashed circle) of the side view of FIG. 21B.

The ratio between the thickness T of the horizontal seal 2100, as shown in FIG. 21A and the height H of the horizontal seal 2100, as shown in FIG. 21B, can vary based on the seal material and gap geometry. In some embodiments using relatively soft seal material, for example 30-durometer, the height H of the horizontal seal 2100 may be substantially (e.g., 20 or 30 or more times) greater than the thickness T of the horizontal seal 2100, similar to gasket geometry. A similar ratio, however, for harder material such as 40-durometer is not as effective. This distinction can be seen in Table 1 row four where an ⅛ inch thick by 6 inch wide seal (32:1 ratio of H:T) with 30-durometer was somewhat effective resulting in no visible leakage along the main section of the beam and only small rivulets near the interfaces, whereas in Table 1 row two, a ¼ inch thick by 6 inch wide seal (24:1 ratio of H:T) of 40-durometer hardness resulted in major leakage with water streaming out from near the interfaces. Under the same load, softer seal materials will flow more easily into grooves, interfaces and open areas, but harder seal materials are often desirable because they generally last longer in that they are more resistant to wear. Harder materials, e.g., 40-durometer, seal effectively with an H:T ratio closer to unity. As seen in Table 1 for the 40—durometer B-1 series seals in rows 5 and 6, the H:T ratio is 3:1 and 7:8 and resulted in very little leakage—only minimal dripping. The length L of the horizontal seal 2100 is set by the width of the module and as a result may be tens or hundreds of folds greater than the thickness T and/or height H of the horizontal seal 2100. It will be understood and appreciated that the dimensions of the horizontal seal 2100 may be customized based on the size of the module stacks.

As best illustrated in FIGS. 21B and 21D, the horizontal seal 2100 need not be a rectangular structure. Near the ends of the horizontal seal 2100 are protruded sections 2110 that provide additional sealing capabilities, and cut outs that provide passage for module integration rod 1910. The protruded section 2110 may be spherical in shape or can take other shapes and configurations (e.g., elliptical, trapezoidal). The protruded section 2110 may extend outwardly from the substantially straight portion (e.g., length L) of the horizontal seal 2100 by about 5%, or by about 10%, or by about 15%, or by about 20%, or by about 25% or more. While only two protruded sections 2110 are shown in FIG. 21B, it is understood that there can be multiple protruded sections 2110 throughout the length L of the horizontal seal 2100. In some embodiments, the protruded section 2110 may be formed with a different material from the rest of the horizontal seal 2100 for enhanced sealing properties.

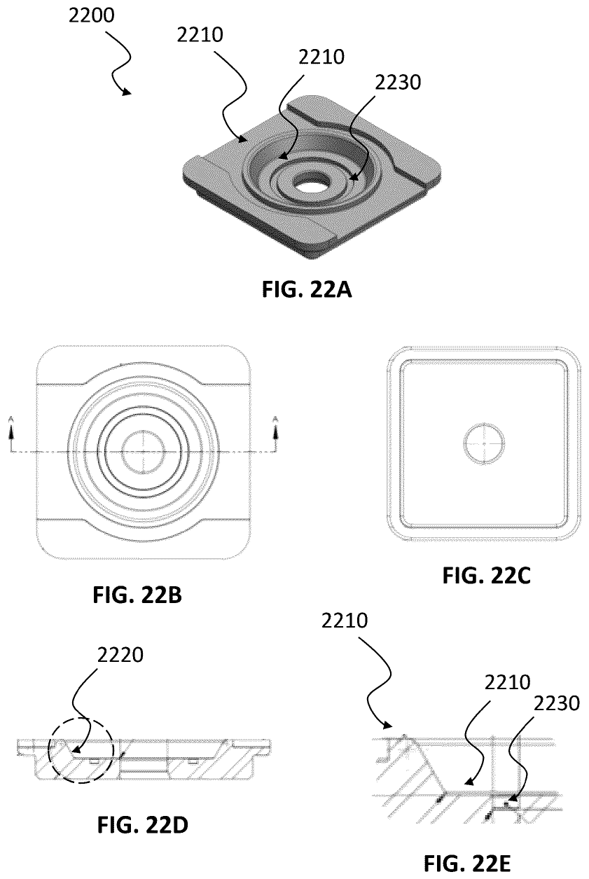

FIGS. 22A-22E are perspective, top, bottom and cross-sectional views of a female column end cap 2200. FIGS. 22A, 22B and 22C are perspective, top and bottom views, respectively, of the female column end cap 2200. FIG. 22D is a cross-sectional view of the center of the end cap 2200 through the A-A dash line of FIG. 22B, and FIG. 22E is a close-up of a portion (represented by dashed circle) of the cross-sectional view of FIG. 22D. In one embodiment, the end cap 2200 can be made of a steel material in accordance with ASTM A36 standards. In other embodiments, the end cap 2200 can be made of other suitable materials (e.g., aluminum, polypropylene, polytetrafluoroethylene (PTFE), stainless steel with nickel alloys, carbon steel) with enhanced corrosion-resistance properties.

As best illustrated in FIG. 22A, the interior of the end cap 2200 can include a plurality of sealing surfaces 2210 at different elevations. The variations in sealing surfaces 2210 help to provide additional sealing capabilities with respect to resisting water ingress into the vertical columns that would expose the module integration rod 1910 to possible corrosion, when the end caps 2200 are applied to the ends of the modules. In some embodiments, the interior of the end cap 2200 with the various sealing surfaces 2210 may have a tapered sidewall 2220 as best illustrated in FIG. 22D. Additionally, near the base of the interior of the end cap 2200 may include an annular groove 2230 configured for receiving an O-ring or other suitable materials.

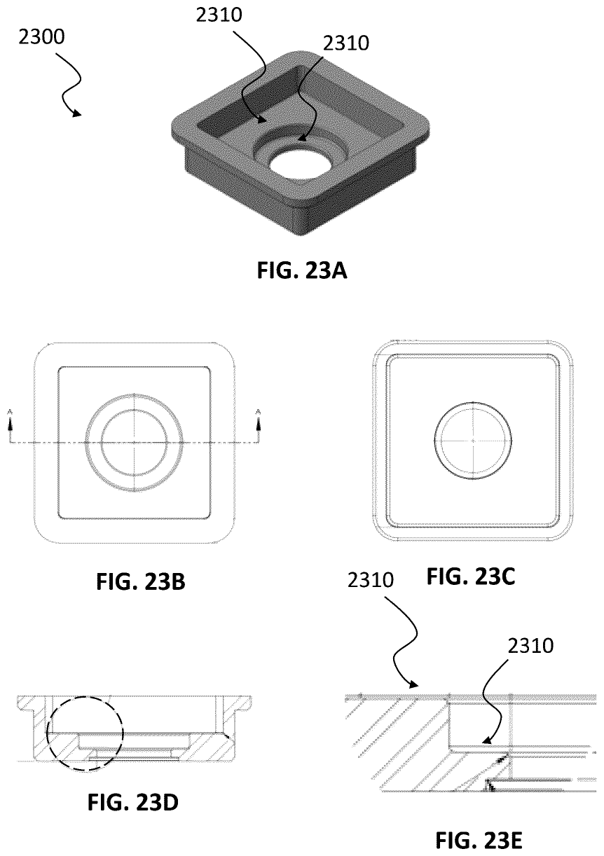

FIGS. 23A-23E are perspective, top, bottom and cross-sectional views of a bottom column end cap 2300. FIGS. 23A, 23B and 23C are perspective, top and bottom views, respectively, of the bottom column end cap 2300. FIG. 23D is a cross-sectional view of the center of the end cap 2300 through the A-A dash line of FIG. 23B, and FIG. 23E is a close-up of a portion (represented by dashed circle) of the cross-sectional view of FIG. 23D. In one embodiment, the end cap 2300 can be made of a steel material in accordance with ASTM A36 standards. In other embodiments, the end cap 2300 can be made of other suitable materials (e.g., aluminum, polypropylene, polytetrafluoroethylene (PTFE), stainless steel with nickel alloys, carbon steel) with enhanced corrosion-resistance properties.

As best illustrated in FIG. 23A, the interior of the end cap 2300 can include a plurality of sealing surfaces 2310 at different elevations. The variations in sealing surfaces 2310 help to provide additional sealing capabilities when the end caps 2300 are applied to the ends of the modules. In some embodiments, the diameter of the upper-most sealing surface 2310 may be greater than the lower-most sealing surface 2310. In other words, the size of the sealing surfaces 2310 at different elevations may decrease with each successive level for improving the sealing functions.

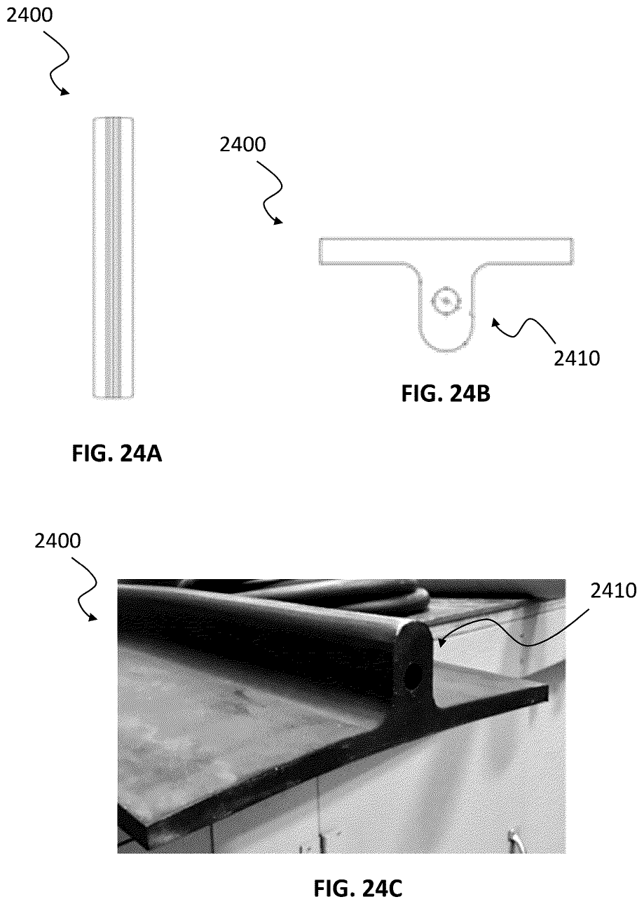

FIGS. 24A-24C are bottom, cross-sectional and perspective views, respectively, of a vertical seal 2400. In some embodiments, the vertical seal 2400 may be formed of same or similar materials (e.g., neoprene, compressible gaskets) as described above.

As best illustrated in FIG. 24B, the vertical seal 2400 may include a protrusion section 2410 disposed about the center, the protruded section 2410 capable of providing additional sealing functions. The protruded section 2410 may be cylindrical in shape or can take other shapes and configurations (e.g., spherical, elliptical, trapezoidal). In some embodiments, the protruded section 2410 may extend outwardly from the vertical seal 2400 by similar ratios of the protruded sections 2110 as described above in FIGS. 21A-21D, and as shown in the photograph in FIG. 24C. In other embodiments, the protruded section 2410 may extend outwardly by a considerable amount. While only one protruded section 2410 is shown in FIG. 24B, it is understood that there may be multiple protruded sections 2410. While only one hole is shown in the protruded section 2410 in FIG. 24B, it is understood that there may be multiple holes in the protruded sections. In some embodiments, the protruded section 2410 may be formed with a different material from the rest of the vertical seal 2400 for enhanced sealing properties (e.g., see FIG. 15E).

While the seals 2100, 2400 and the end caps 2200, 2300 discussed above are with respect to vertical or horizontal module stacks, it will be understood and appreciated by one skilled in the art that the seals 2100 and 2400 end caps 2200, 2300 may be used interchangeably with appropriate modification. In other words, vertical seals 2400 may be used as horizontal seals 2100, and vice versa. Similarly, the end caps 2200, 2300 may also be used interchangeably for integration of the module stacks. To interchange them one must appreciate that the horizontal seals 2100 rely on the compression achieved by the weight of the modules 104 and the force exerted by the module integration rod 1910 to complete an effective seal against water leakage. Horizontal seals may be used as vertical seals if sufficient horizontal clamping force is provided between the stacks. Whereas the vertical seals 2400 rely on the pressure from the water to achieve the seal. For vertical seals used in the upstream position FIG. 19 the water may press the flange against the stacks and cause the region with the protruding bulb to bend into the vertical gap and press up against the sides of the vertical gap to achieve the seal. For vertical seals used on the downstream side (e.g., FIG. 15C) the water may press directly on the protruding bulb portion of the seal causing it to expand up against the sides of the vertical gap. As a result, vertical seals may be used for horizontal seals with minimal modification to the system.

In one embodiment, a system 100 includes a plurality of modules 104, 1904 assembled to form at least one stack 105, 1905. In this embodiment, the at least one stack includes vertical seals similar to seals 2100, 2400, whereby the vertical seals are installed vertically between each of the plurality of modules 104, 1904. In another embodiment, the at least one stack includes horizontal seals similar to seals 2100, 2400, whereby the horizontal seals are installed horizontally between each of the plurality of modules 104, 1904. In operation, the vertical seals and the horizontal seals are configured to prevent leakage and provide near water-tight connection.

In one embodiment, each of the vertical seals described above may include at least one protruded section similar to the protruded sections 2110, 2410. Likewise, in another embodiment, each of the horizontal seals may include at least one protruded section similar to the protruded section 2110, 2410. In some embodiments, the system 100 may further include a post-tension anchor 1202 securing the at least one stack 105, 1905 to a foundation.

In operation, a collection of one or more integration parts such as those described above, e.g., module integration rod 1910, male end cap 1920, horizontal seal 2100, female end cap 2200, and vertical seal 2400, can help to provide better sealing capabilities than previously known sealants for the module stacks.

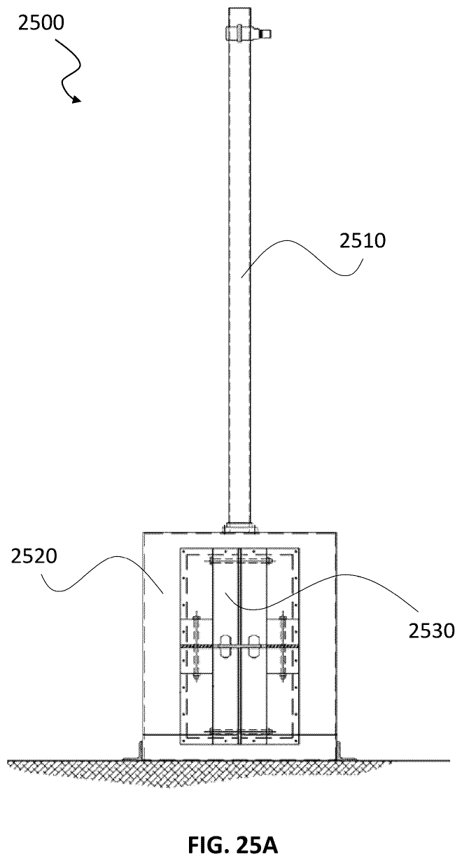

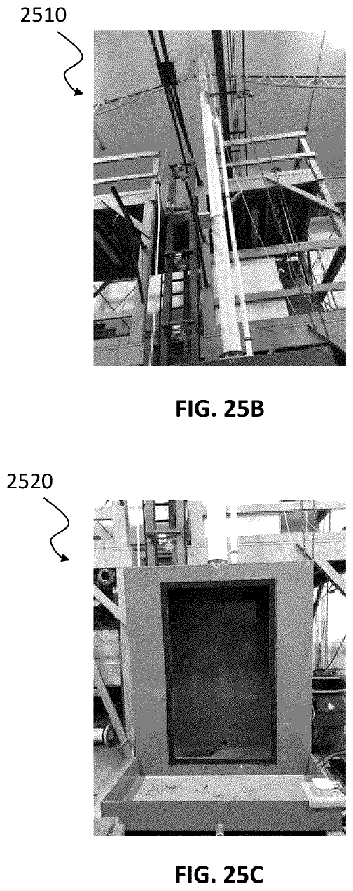

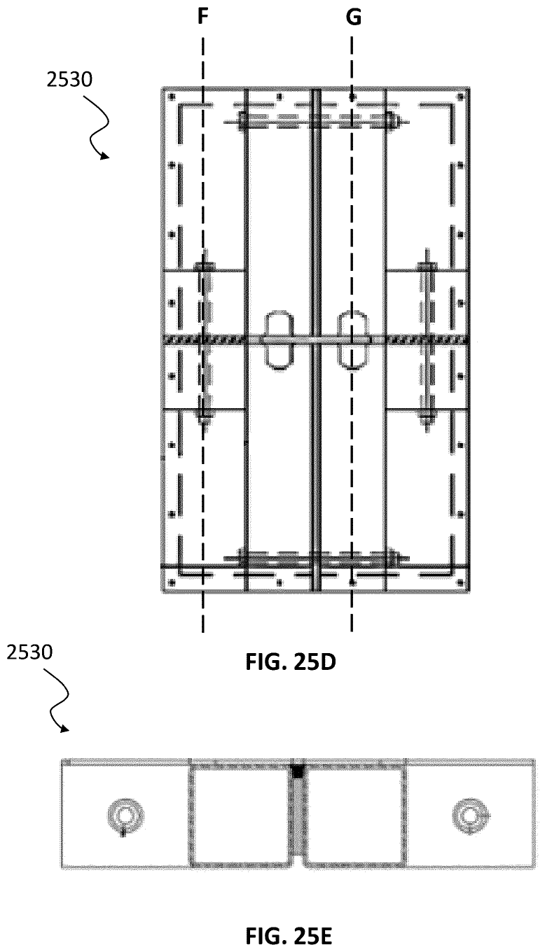

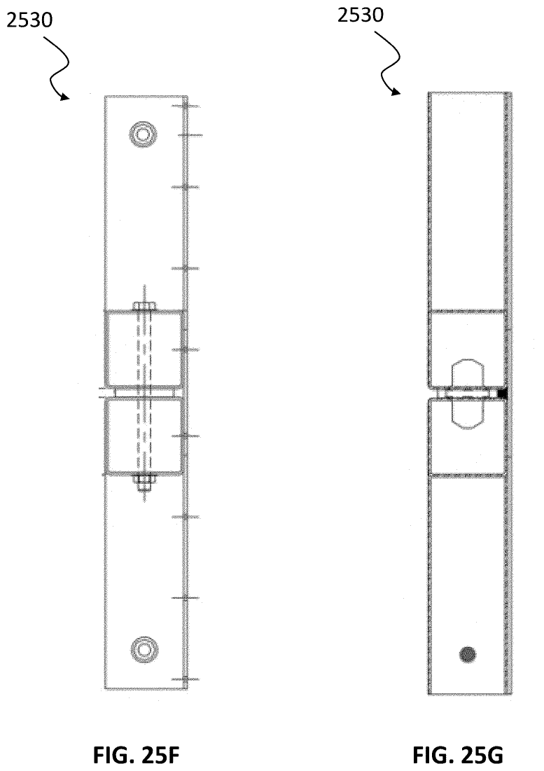

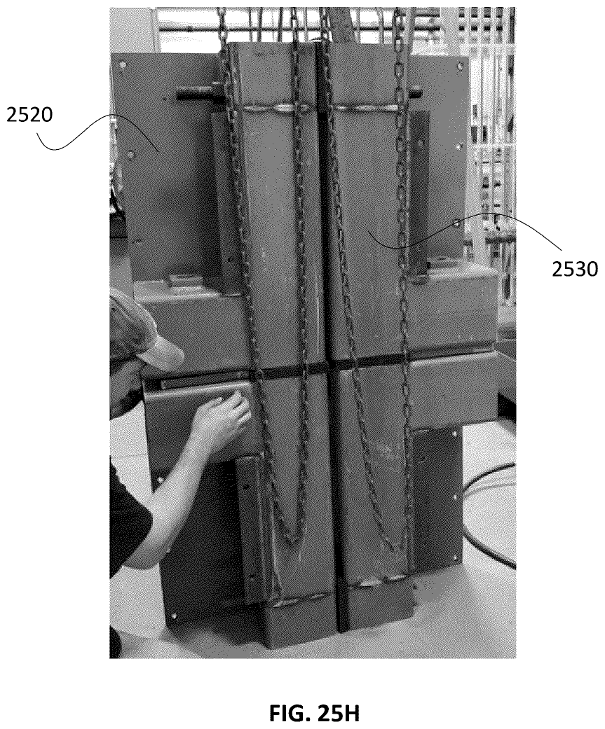

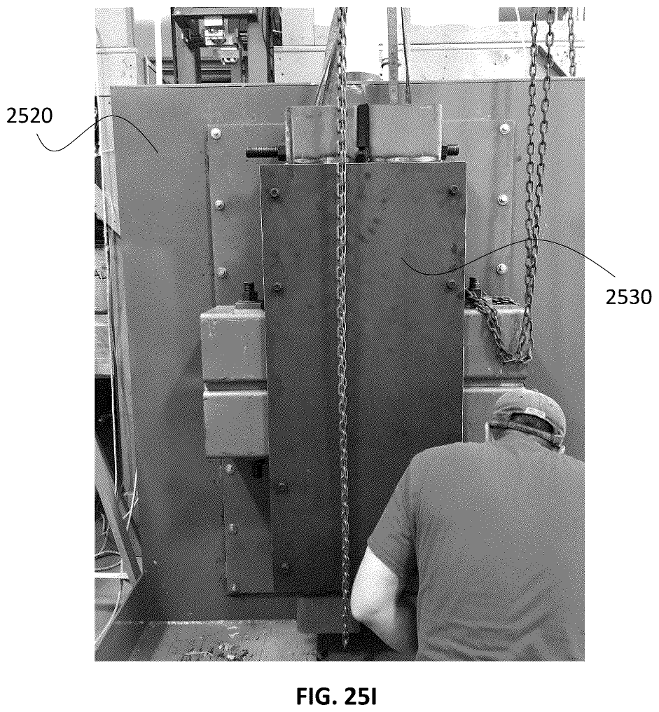

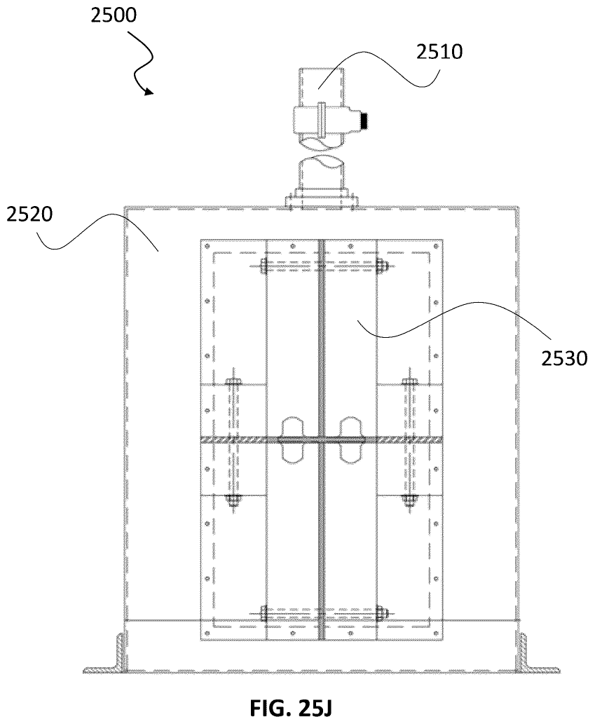

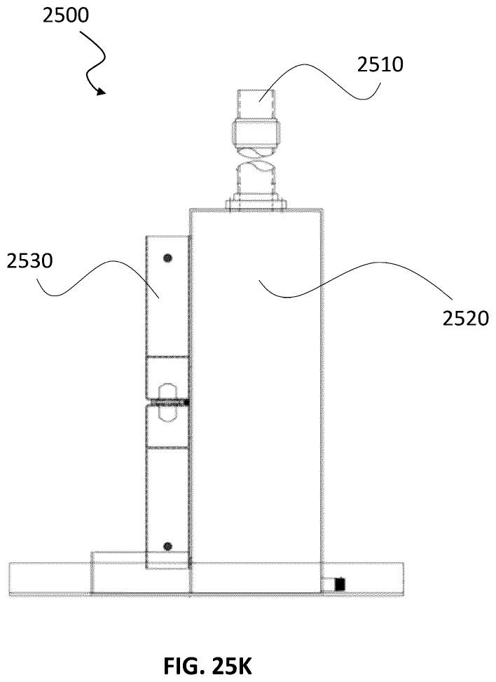

FIGS. 25A-25K are images and photographs of a test apparatus 2500 for testing leakage level for vertical and horizontal seals of a module stack according to an embodiment of the present disclosure. In one embodiment, the test apparatus 2500 includes a test fixture 2530 and a test tank 2520 having a standpipe 2510 as shown in FIGS. 25A, 25J and 25K. The use of the test apparatus 2500 and associated method for assessing the effectiveness of sealing the horizontal and vertical joints through testing is described below.

Since the SSPMH is innovative, there is no existing testing standard that is applicable to testing leakage through the seals. There is some general guidance from ANSI/FM Approvals 2510, which is a standard stating the examination and test requirements for flood mitigation equipment. Accordingly, disclosed herein according to an embodiment is a test method to expose true-scale SSPMH module junctions having vertical and horizontal seals to operational-level head pressures, observe and measure the leakage through the seals, compare the leakage rates against the selected standards, and use the information gained to confirm or modify the seal design.

In one embodiment, the test apparatus 2500 includes four components: a test tank 2520 (as best illustrated in FIGS. 25A, 25J and 25K), a vertical standpipe 2510 (as best illustrated in FIGS. 25A, 25J and 25K), a leakage collection and measurement system (not shown), and a test fixture 2530 (as best illustrated in FIGS. 25D-25G).

In one embodiment, as shown in FIGS. 25A-25C, the test tank 2520 includes a main steel chamber (e.g., 5-foot wide by 1-foot-11-⅝-inch deep by 5-foot-10-⅞-inch tall with ⅜-inch-thick wall) that is continuously seal welded on all seams, and a standpipe 2510 (e.g., 6-inch diameter by 25-foot tall in total with the test tank 2520) that extends from the top of the test tank 2520. The standpipe 2510 is mounted to the test tank 2520 using commercially available flange and pipe gaskets. On the face of the test tank 2520 is an opening (e.g., 2-foot-10-⅞-inch wide, 4-foot-8-⅞-inch tall) over which the test fixture 2530 can be mounted as best illustrated in FIGS. 25J-25K. In operation, the test tank 2520 with the standpipe 2510 contains water to provide the head pressure for the seal test.

The test fixture 2530 as illustrated in FIGS. 25D-25G (FIG. 25E is a top-down view of FIG. 25D while FIGS. 25F and 25G are sectional views through dashed lines F and G as illustrated in FIG. 25D) can be made up of four pieces that provide a true-scale physical model of the system at corners where four modules come together as best shown in FIGS. 25H-251. Each piece of the physical model (a module corner) can be made so that it fits together with the other three pieces of the physical model (each a module corner) in a way to include contiguous lengths of true-scale horizontal and vertical seals. Each piece includes the frame elements and the bulkhead. The four pieces bolt together to make a true-scale model of the four-corner junction.

In operation, a method of using a test apparatus according to an embodiment includes: (a) assemble a test tank 2520, (b) attach a test fixture 2530 with seals, (c) attach a stand pipe 2510 to the test tank 2520, (d) fill the stand pipe 2510 with water, (e) observe and photograph results, (0 collect water (if any) that leaks out and is caught in a catch basin (not shown), (g) continue collection step (0 and weigh the water in the catch basins every 30 minutes, (h) report weight and volume of water collected, (i) calculate and report leakage rate in gallons per minute per linear foot of seal (gpm/lf), (j) compare result to the leakage standard of 0.10 gpm/lf.

Table 1 below summarizes a variety of module-to-module seal configurations and their effectiveness at resisting leakage as evaluated using the test apparatus and methods described above. The seals in seal sets A-1 and A-2, rows 1-4 of Table 1, represent the standard approach for sealing flat plates; flat pieces of neoprene as specified in column 3 of Table 1 with the dimensions presented in columns 5-8 of Table 1 were sandwiched between module beams in horizontal and vertical locations where the water was expected to flow through. In this test series the standpipe 2510 was filled to achieve 15 feet 10 inches of water height including the depth of the test tank 2520. Test of the A series of seals resulted in substantial observed leakage that did not, by inspection, meet the selected leakage standard of a maximum of 0.10 gpm/lf. High volume, high velocity leakage was observed particularly at the intersections of the neoprene seals and steel spacer plates and alignment cones. Based on visual inspection, the seals in A-2 performed moderately well. Because the test apparatus collects the water that leaks out of the entire test fixture 2530 seal system it is not possible to isolate a quantitative leakage rate of the A-2 seals from the A-1 seals, but visually one could observe that the leakage from the A-2 seal area was characterized by small rivulets near interfaces as opposed to fast streaming water leaking out near the A-1 seals. The A-2 seal is a soft material, 30-durometer, that is easier to extruded into spaces, grooves, and gaps than the harder, 50-durometer, material used in the A-1 seals, which explains its somewhat better sealing ability.

Test 2 used horizontal seal set B. The B seals were 1 inch thick and included a straight section 3 inches wide and an end wrap section ⅞ inch wide in the shape represented by half of the length of the image shown in FIG. 15F. The B series horizontal seals were sandwiched between the horizontal beams of the test fixture 2520. The B seals were made of 40-durameter neoprene. Test 2 used vertical seals, B-1, that included a hollow tube of neoprene pressed into the vertical gap and a cover plate that spanned the vertical gap and included o-rings and hydrophilic rubber to seal up against the vertical beam members. FIG. 15E shows an overhead cross sectional view of the seal configuration used in Test 2. The total length of this seal configuration summing up the two horizontal seals and vertical seal was 6.48 linear feet. Test 2 started out using 15 feet 10 inches of water elevation. Leakage was collected in the collector pan at the bottom of the test fixture 2530 and the amount of water collected was weighed every 30 minutes. In the first 30-minute period 117.75 pounds of water were collected, which corresponds to 14.11 gallons of water and an average leakage rate of 0.46 gpm. In the second 30-minute period, 106.75 lbs of water were collected, which corresponds to 12.79 gallons and an average leakage rate of 0.43 gpm. The total leakage over both periods corresponds to an average leakage rate of 0.45 gpm. Using the maximum leakage rate of 0.47 gpm over the 6.48 linear feet of seal results in a leakage of 0.073 gpm/lf, which is less than the standard of 0.1 gpm/lf. Visual observation revealed very little leakage described as very minimal dripping. Most of the leakage was from the test apparatus, thus the leakage value of 0.073 gpm/lf is a very conservative estimate of the performance of this seal configuration. The leakage from the seals could not be separated from the leakage from the test fixture, but based on the description of the observed minimal dripping one may estimate a leakage rate of 1-20 gallons per day, since the typical leaking home faucet leaks at about 1 gallon day and a leaky shower drips at about 11 gallons a day (see, e.g., USGS drip calculator at https://water.usgs.gov/edu/activity-drip.html). At a conservative leakage of 20 gallons per day the average leakage rate would be 0.014 gpm which would correspond to 0.002 gpm/lf for the seals in Test 1. At a water elevation of 25 feet the leakage at the seals was similar.

Test 3 also used horizontal seal set B, but used vertical seals, B-2, that were characterized by a “T” shape with a flange and protrusion as shown in FIG. 24B and FIG. 24C. The protrusion was pressed into the vertical gap and a cover plate that spanned the vertical gap was placed over the flange to hold the seal in place. The total length of this seal configuration summing up the two horizontal seals and vertical seal was also 6.48 linear feet. Test 3 also started out using 15 feet 10 inches of water elevation. Leakage was collected in the collector pan at the bottom of the test fixture 2530 and the amount of water collected was weighed every 30 minutes. In the first 30-minute period 86.99 pounds of water were collected, which corresponds to 10.42 gallons of water and an average leakage rate of 0.35 gpm. In the second 30-minute period, 87.80 lbs of water were collected, which corresponds to 10.52 gallons and an average leakage rate of 0.35 gpm. The total leakage over both periods corresponds to an average leakage rate of 0.35 gpm. Using the maximum leakage rate of 0.35 gpm over the 6.48 linear feet of seal results in a leakage of 0.054 gpm/lf, which is less than the standard of 0.1 gpm/lf. Visual observation reported “no visible leakage through seals,” suggesting a leakage of 0.00 gpm/lf. At a water elevation of 25 feet the leakage was similar.

Test 1

| | | | | | | | | | |
|---|---|---|---|---|---|---|---|---|---|
| 1 | A1 | Horizontal | Neoprene, smooth face, 50 durameter | sections amid | 6″ | 1″ | 3:4 | 1.6 | streaming near interfaces |
| | | | 820 psi tensile strength, 400% | steel spacers | | | | | and across face |
| 2 | | | elongation, −20° F. to +170° F. | | 6″ | ¼″ | 3:4 | 1.24 | streaming near interfaces |
| | | | ASTM D-2000 | | | | | | |
| 3 | | Vertical | 1BC408/508/609/710SAEJ200 | section ended | 6″ | 1″ | 3:4 | 1.6 | gushing or streaming at/near |
| | | | | at quad point | | | | | quad point |
| 4 | A1 | Horizontal | Neoprene, 30-durometer | | “ | ⅛″ | 3:4 | 1:32 | small revlettes near |
| | | | | | | | | | interfaces, no leakage along |
| | | | | | | | | | main sections |

Test 2

| | | | | | | | | | |
|---|---|---|---|---|---|---|---|---|---|
| 5 | 8 | Horizontal | Neoprene, smooth face, 40 durometer | continuous | 3″ | 1″ | 1:3 | 1:3 | very minimal dripping: |
| | | | 1000 psi tensile strength, 350% | w/end wraps | | | | | |
| | | | elongation, −20° F. to +170° F. | | | | | | |
| 6 | | Horizontal | ASTM2000BC | | ⅞″ | 1″ | n/a | 8:7 | leakage mostly from test |
| | | end wraps | Elongated 1¼″ OD w/ [symbol] ″ ID gap | | | | | | of fixture: total leakage .073 |
| | | | steel, four beds | | | | | | gpm/lf |
| | | | Neoprene 50-durometer | | | | | | |
| 7 | 8-1 | Vertical | 2005T solid hydraulic rubber | on steel backer plate, | | | | | |
| | | | | spanning seam and | | | | | |
| | | | | crossing over and | | | | | |
| | | | | spanning quad point | | | | | |

Test 3

| | | | | | | | | | |
|---|---|---|---|---|---|---|---|---|---|
| 8 | 8 | Horizontal | Neoprene, smooth face, 40 durometer | continuous | 3″ | 1″ | 1:3 | 1:3 | no visible leakage through |
| | | | 1000 psi tensile strength, 350% | w/end wraps | | | | | |
| | | | elongation, −20° F. to +170° F. | | | | | | |
| 9 | | Horizontal | ASTM 2000BC | | ⅞″ | 1″ | n/a | 8:7 | seals, leakage was mostly |
| | | end wraps | Neoprene 50-durometer shore A ASTM | | | | | | test appearance, and test |
| | | | 10″ wide by ½″ thick w/1¾″ rounded | | | | | | |
| | | | test fixture D2240, 2000 psi tensile | | | | | | |
| | | | strength ASTM protuberance w/½″ | | | | | | |
| | | | round spanning | | | | | | |
| 10 | 8-2 | Vertical | D412, 400% elongation ASTM D412, 30% | crossing over & spanning | | | | | |
| | | | full length vertical seam mass | quad point | | | | | |
| | | | compression set ASTM D395 | | | | | | |

[symbol]

indicates data missing or illegible when filed

Seals for modular dam or hydropower facility and test results.

As a result of the test apparatus and test method, the following guidelines can be used for specifying seal geometry and material properties for module-to-module seals for modular dams or hydropower facilities according to the present disclosure.

In one embodiment, there are observations of leaks at interfaces between the seals and steel plates that appear to be caused by a flow path between seal and steel plate ends. Proposed solution includes combining spacers and shims, among others, to reduce the number of interfaces in the seal area, place seal material upstream of plates and shims as much as possible, and make seals as a single piece to eliminate joints, to name a few.

In one embodiment, there are observations of leaks over the surfaces of steel plates, but not when there is a thin, soft gasket placed on the surface of the steel plate, which may be caused by flow path across steel-on-steel contact surfaces. Proposed response includes use of thin, soft (e.g., less than 50-durameter, 30-durameter preferred) neoprene on top and bottom of any steel spacer/shim plates, to name a few.

In one embodiment, there are observations of high torque on through bolts needed to compress horizontal seals, which appear to be caused by stiff horizontal seals with large surface area thus lowering unit area stress and effectiveness. Proposed response includes reducing width of horizontal seal strip to less than half of the beam width, and reducing stiffness of horizontal seal neoprene material to less than 50-durometer, to name a few.

In one embodiment, there are observations of leakage in the vertical joint, which may be caused by difficulty in adequately compressing neoprene in vertical joints. One solution includes redesigning vertical joint seal by: redundant sealing system, “T-seal” configuration, hollow bulb seal in vertical joint, neoprene flange with knobs for sealing against downstream face or provide seal compression/confinement with downstream backer plate. Alternative solution includes redesigning vertical joint seal by: redundant sealing system, independent hollow cylinder strip seal in vertical joint, provide seal compression/confinement with downstream backer plate, twin O-ring stock seal lines (each) side seated in backer plate to seal against downstream face, and hydrophilic “swell stop” water stop strip on each side seated in backer plate to seal against downstream face and confined by O-ring stock seals, to name a few.

In one embodiment, observations of leakage at four corner intersection appear to be caused by seals not continuous through the corners. Proposed response includes making vertical seal continuous across corner intersection, to name a few.

In one embodiment, observations of potential flow path through corner block holes may be caused by direct flow path through corner block side and to/bottom holes to downstream end hole. Proposed solution includes eliminating side and downstream end corner block holes, to name a few.

In one embodiment, observations of potential for change in vertical joint width due to thermal expansion/contraction appear to be caused by change in width of adjacent modules due to thermal expansion/contraction of steel. Proposed responses include: (a) calculating potential change in joint width: (i) coefficient of Thermal Expansion for MOO, Grade B, 46 ksi steel=6.7×10⁻⁶/Deg. F, (ii) module nominal width=8.0 feet, (iii) assume±50 Deg. F. change in temp possible from initial install, and (iv) 8 ft×6.7×10⁻⁶/Deg. F×50°=0.0027 ft.=0.0322 in.=− 1/32″; and (b) redesigning vertical seal to accommodate change in joint width through: (i) oversizing vertical neoprene seal in joint to accommodate expansion, (ii) provide hollow vertical neoprene seal in joint to accommodate compression, and (iii) provide oversize (oval) backer plate bolt holes to accommodate movement, to name a few.

In one embodiment, observations of vertical seals that are hard to replace particularly during module replacement may be caused by limited access after the modules are in place or seals that are hard to install during module replacement. Proposed responses include redesigning vertical seals for access from downstream end or redesigning vertical seals for installation after modules are in place, to name a few.

In one embodiment, design issues related to manufacturing tolerances may be resolved by sizing and configuring horizontal seals to provide for slight space around steel plates and being prepared to trim seals if needed, to name a few.

In one embodiment, design issues related to possible tearing of neoprene seals at corners may be resolved by rounding internal return corners of horizontal seals to prevent stress concentrations and rounding corners of steel spacer/shim plates to prevent cutting, to name a few.

While example embodiments have been particularly shown and described, it will be understood by those skilled in the art that various changes in form and details may be made therein without departing from the scope of the embodiments encompassed by the appended claims. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. An assembly comprising:
a first vertical stack having a first module and a second module made of cast-in-place concrete with or without bar or fiber reinforcement, or precast concrete with or without bar or fiber reinforcement, or steel alloy, or aluminum alloy, or glass fiber reinforced plastic, or carbon reinforced plastic or a hybrid or combination of any two or more of these materials, and a first seal horizontally installed between the first module and the second module;
a second vertical stack having a third module and a fourth module made of cast-in-place concrete with or without bar or fiber reinforcement, or precast concrete with or without bar or fiber reinforcement, or steel alloy, or aluminum alloy, or glass fiber reinforced plastic, or carbon reinforced plastic or a hybrid or combination of any two or more of these materials, and a second seal horizontally installed between the third module and the fourth module;
a third seal vertically installed between the first module and the third module, the third seal configured to span across vertical joints between the first vertical stack and the second vertical stack; and
wherein the horizontal seals and the vertical seals, are configured to provide near water-tight connections between the horizontal joints and the vertical joints such that the assembly has a leakage rate of less than about 0.1 gallon per minute per linear foot of joint.

2. The assembly of claim 1, wherein at least one of the horizontal seals, and the vertical seals includes a protruded section.

3. The assembly of claim 2, wherein at least one of the horizontal seals and vertical seals is installed on an upstream side of the assembly.

4. The assembly of claim 2, wherein at least one of the horizontal seals and vertical seals is installed on a downstream side of the assembly.

5. The assembly of claim 1, further comprising a water-retaining bulkhead on an upstream side of at least one of the first vertical stack and the second vertical stack.

6. The assembly of claim 1, further comprising a water-retaining bulkhead on a downstream side of at least one of the first vertical stack and the second vertical stack.

7. The assembly of claim 1, further comprising an integration rod that secures at least one of the first module and the second module, and the third module and the fourth module.

8. The assembly of claim 1, further comprising a post-tension anchor securing the at least one of the first vertical stack and the second vertical stack to a foundation.

9. An assembly comprising:
a first plurality of modules assembled to form a first vertical stack;
a second plurality of modules assembled to form a second vertical stack, wherein each of the first vertical stack and the second vertical stack includes at least one of:
a first plurality of horizontal seals between the first plurality of modules, and second plurality of horizontal seals between the second plurality of modules; and
a plurality of vertical seals installed between the first plurality of modules and the second plurality of modules;
wherein the first plurality of horizontal seals, the second plurality of horizontal seals, and the plurality of vertical seals are configured such that the system has a leakage rate of less than about 0.1 gallon per minute per linear foot of joint.

10. The assembly of claim 9, wherein at least one of the first plurality of horizontal seals, the second plurality of horizontal seals, and the plurality of vertical seals includes a protruded section.

11. The assembly of claim 10, wherein at least one of the first plurality of horizontal seals, the second plurality of horizontal seals, and the plurality of vertical seals is installed on an upstream side of the assembly.

12. The assembly of claim 10, wherein at least one of the first plurality of horizontal seals, the second plurality of horizontal seals, and the plurality of vertical seals is installed on a downstream side of the assembly.

13. The assembly of claim 9, further comprising a water-retaining bulkhead on an upstream side of at least one of the first vertical stack and the second vertical stack.

14. The assembly of claim 9, further comprising a water-retaining bulkhead on a downstream side of at least one of the first vertical stack and the second vertical stack.

15. The assembly of claim 9, further comprising an integration rod that secures at least one of the first plurality of modules and the second plurality of modules.

16. The assembly of claim 9, further comprising a post-tension anchor securing the at least one of the first vertical stack and the second vertical stack to a foundation.

17. A system comprising:
an assembly configured to secure to a foundation, wherein the assembly includes:
a first vertical stack having first module and second module, and first seal horizontally installed between the first module and the second module;
a second vertical stack having third module and fourth module, and second seal horizontally installed between the third module and the fourth module;
a third seal vertically installed between the first module and the third module, and between the second and fourth module, the third seal configured to span across vertical joints between the first module and the third module and to span across vertical joints between the second module and the fourth module, which includes the quad point;
wherein the first seal, the second seal, and the third seal are configured to provide low-leakage connections between and among the first module, the second module, the third module, the fourth module of the first vertical stack and the second vertical stack such that the system produces acceptable leakage levels.

18. The system of claim 17, wherein at least one of the first seal, the second seal, and the third seal is installed on at least one of upstream side and downstream side of the assembly.

19. The system of claim 17, further comprising a water-retaining bulkhead on at least one of upstream side and downstream side of the assembly.

20. The system of claim 17, further comprising first integration rod that secures at least one of the first module and the second module, and the third module and the fourth module, and second integration rod that secures at least one of the first vertical stack and the second vertical stack to the foundation.

21. An assembly comprising:
a first vertical stack having a first module, and a first seal horizontally installed between the first module and a foundation on which the assembly is disposed;
a second vertical stack having a second module, and a second seal horizontally installed between the second module and the foundation;
a third seal vertically installed between the first module and the second module, the third seal configured to span across vertical joints between the first vertical stack and the second vertical stack; and
wherein the horizontal seals and the vertical seal, are configured to provide near water-tight connections between the vertical joints such that the assembly has a leakage rate of less than about 0.1 gallon per minute per linear foot of joint.

22. The assembly of claim 21, wherein at least one of the horizontal seals and the vertical seals includes a protruded section.

23. The assembly of claim 22, wherein at least one of the horizontal seals and vertical seals is installed on an upstream side of the assembly.

24. The assembly of claim 22, wherein at least one of the horizontal seals and vertical seals is installed on a downstream side of the assembly.

25. An assembly comprising:
a first vertical stack having a first module and a second module, and a first seal horizontally installed between the first module and the second module;
wherein the horizontal seal is configured to provide near water-tight connections between horizontal joints of the first and second module such that the assembly has a leakage rate of less than about 0.1 gallon per minute per linear foot of joint.

26. The assembly of claim 25, wherein the horizontal seal includes a protruded section.

27. The assembly of claim 26, wherein the horizontal seal is installed on an upstream side of the assembly.

28. The assembly of claim 26, wherein at the horizontal seal is installed on a downstream side of the assembly.
